(19) United States
(12) Patent Application Publication
(10) Pub. No.: US 2018/0143755 A1
(43) Pub. Date: May 24, 2018

(54) INFORMATION PROCESSING DEVICE, METHOD FOR CONTROLLING INFORMATION PROCESSING DEVICE, TERMINAL DEVICE, CONTROL PROGRAM, AND RECORDING MEDIUM

(71) Applicant: SHARP KABUSHIKI KAISHA, Sakai City, Osaka (JP)

(72) Inventors: MASAFUMI UENO, Sakai City (JP); NAOKI SHIOBARA, Sakai City (JP)

(21) Appl. No.: 15/574,986

(22) PCT Filed: Mar. 9, 2016
(86) PCT No.: PCT/JP2016/057455

§ 371 Date: Nov. 17, 2017

(30) Foreign Application Priority Data
May 21, 2015 (JP) 2015-103919

(51) Int. Cl. G06F 3/0488; G06F 3/00; G06K 19/067; G06F 3/041

(52) U.S. Cl. CPC G06F 3/0488; G06F 3/041; G06K 19/067; G06F 3/002

(57) ABSTRACT

An information processing device configured to display an image in a display area corresponding to a transparent area, a smaller housing applied thereto. The information processing device includes an application execution unit (211) configured to identify an area of the NFC display (11) corresponding to the transparent area (31) of the NFC terminal (30) based on the position information on the NFC terminal (30) output from the touch panel (14), and a display drive unit (23) configured to display an image in the identified area.

### TECHNICAL FIELD

The present invention relates to an information processing device configured to display an image in a display area corresponding to a light-transmitting portion of a terminal device.

### BACKGROUND ART

In the related art, information processing devices are provided which execute processes in response to contact with (or proximity to) a display. For example, card game apparatuses have been developed in which card games are played by placing or moving card-shaped terminal devices on a display. However, with respect to the above-described information processing devices, as terminal devices are placed on the display, the display of images may be limited. Specifically, in a case that an image is displayed as a result of placing the terminal device, the image displayed at the position where the terminal device is placed is invisible to the user.

PTL 1 discloses a technique for reading an invisible reference mark, QR code (registered trademark), which can be detected by infrared light incident on a card including a light-transmitting portion (transparent area), and displaying an image in a display area corresponding to the transparent area of the card.

### CITATION LIST

### Patent Literature

PTL 1: JP 2009-297303 A (published on Dec. 24, 2009)

### SUMMARY OF INVENTION

### Technical Problem

However, in the technique of PTL 1, in order to identify the transparent area of the card, it is necessary to provide a CCD camera for reading the reference mark or the QR code at the bottom of the display, leading to problems preventing the size of the housing from being reduced.

The invention has been made in view of the above problems, and an object of the invention is to provide an information processing device configured to display an image in a display area corresponding to a transparent area of a terminal device and including a smaller housing.

### Solution to Problem

In order to solve the above problems, an information processing device according to one aspect of the present invention includes: a display unit on which a terminal device is able to be placed, the display unit including a light-transmitting portion, the display unit including a touch panel; an area identification unit configured to identify, based on position information on the terminal device output from the touch panel in a case that the terminal device is placed on the display unit, an area of the display unit corresponding to the light-transmitting portion; and a display control unit configured to display an image in the identified area.

In addition, in order to solve the above problems, a method for controlling an information processing device according to one aspect of the invention is a method for controlling an information processing device including a display unit on which a terminal device including a light-transmitting portion is able to be placed, the display unit including a touch panel. Such a method includes: an area identification step for identifying, based on position information on the terminal device output from the touch panel in a case that the terminal device is placed on the display unit, an area of the display unit corresponding to the light-transmitting portion; and a display control step for displaying an image in the identified area.

In addition, in order to solve the above problems, an information processing device according to one aspect of the invention includes: a display unit including a communication device configured to establish Near field radio communication with a terminal device including a light-transmitting portion; a storage unit configured to store communication position information indicating a position of the communication unit in the display unit; a terminal position identification unit configured to identify, in response to establishment of Near field radio communication, a position where the terminal device is in contact with or in proximity to in the display unit using the communication position information; an area identification unit configured to identify an area of the display unit corresponding to the light-transmitting portion of the identified terminal device; and a display control unit configured to display an image in the identified area.

In addition, in order to solve the above problems, a terminal device according to one aspect of the invention is a terminal device configured to establish Near field radio communication with an external device by being placed on a display unit of the external device. Such a terminal device includes a light-transmitting portion through which at least a portion of an image displayed on the display unit is visible in a case that the terminal device is placed on the display unit.

### Advantageous Effects of Invention

According to one aspect of the invention, it is possible to reduce the size of the housing of the information processing device configured to display an image in a display area corresponding to a transparent area of a terminal device.

### BRIEF DESCRIPTION OF DRAWINGS

FIG. 1 is a block diagram illustrating an example of a primary configuration of an information processing device according to a first embodiment.

FIG. 2 is a diagram illustrating specific examples of an NFC terminal.

FIG. 3 is a diagram illustrating, as an orthographic drawing, each face of the NFC terminal illustrated in FIG. 2A.

FIG. 4 is a cross-sectional view, taken along A-A, of the NFC terminal illustrated in A of FIG. 3.

FIG. 5 is a cross-sectional view, taken along B-B, of the NFC terminal illustrated in B of FIG. 3.

FIG. 6 is a diagram illustrating a specific configuration of the NFC display illustrated in FIG. 1.

FIG. 7A is a diagram illustrating an example of the NFC terminal. FIG. 7B illustrates a specific example of NFC information based on information acquired from the NFC terminal illustrated in FIG. 7A.

FIG. 8A is a diagram illustrating another example of the NFC terminal. FIG. 8B illustrates a specific example of the NFC information based on information acquired from the NFC terminal illustrated in FIG. 8A.

FIG. 9 is a flowchart illustrating an example flow of processing executed by the information processing device illustrated in FIG. 1.

FIG. 10 is a transition diagram of the information processing device 1 illustrated in FIG. 1 executing an application.

FIG. 11 is a diagram illustrating a specific configuration of an NFC display provided in an information processing device according to a second embodiment.

FIG. 12 is a transition diagram of the information processing device according to the second embodiment executing an application.

FIG. 13 is a block diagram illustrating an example of a primary configuration of an information processing device according to a third embodiment.

FIG. 14 is a diagram illustrating a specific configuration of the NFC display illustrated in FIG. 13.

FIGS. 15A and 15B are diagrams for explaining the principles of the touch panel illustrated in FIG. 13. FIGS. 15C and 15D are diagrams for explaining an example of a sensor signal generated in a case that an object comes into contact with the touch panel.

FIG. 16A is a diagram illustrating an example of each parameter of a terminal candidate area identified by shape analysis. FIG. 16B illustrates a specific example of touch information in a case that the object is a rectangular NFC terminal.

FIG. 17A illustrates a specific example of touch information generated in a case that the NFC terminal comes into contact with a touch panel. FIG. 17B illustrates a specific example of touch information in a case that the NFC terminal is moved while maintaining contact with the touch panel.

FIG. 18 illustrates a specific example of association data.

FIG. 19 is a flowchart illustrating an example flow of processing executed by the information processing device illustrated in FIG. 13.

FIG. 20 is a flowchart illustrating an example flow of the association process included in the flowchart of FIG. 19.

FIG. 21 is a transition diagram illustrating the information processing device illustrated in FIG. 13 executing an application.

FIG. 22 is a diagram illustrating a specific configuration of an NFC display provided in an information processing device according to a fourth embodiment.

FIG. 23 is a transition diagram illustrating the information processing device according to the fourth embodiment executing an application.

FIG. 24 is a block diagram illustrating an example of a primary configuration of an information processing device according to a fifth embodiment.

FIG. 25 is a transition diagram illustrating the information processing device according to the fifth embodiment executing an application.

FIG. 26 is a diagram illustrating, as an orthographic drawing, each face of a card-shaped NFC terminal according to a sixth embodiment.

FIG. 27 illustrates a front view and rear view of the card-shaped NFC terminal according to the sixth embodiment.

FIG. 28 is a diagram illustrating, as an orthographic drawing, each face of a card-shaped NFC terminal according to a modification of the sixth embodiment.

FIG. 29 is a diagram illustrating another example of a rod-shaped grip portion according to a modification of the sixth embodiment.

### DESCRIPTION OF EMBODIMENTS

### First Embodiment

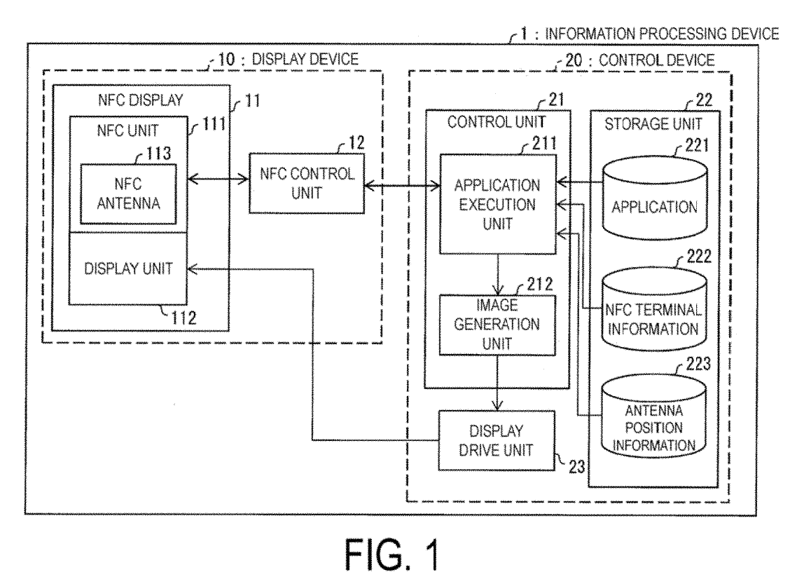

Hereinafter, embodiments of the present invention will be described with reference to FIG. 1 to FIG. 10.

### NFC Terminal 30

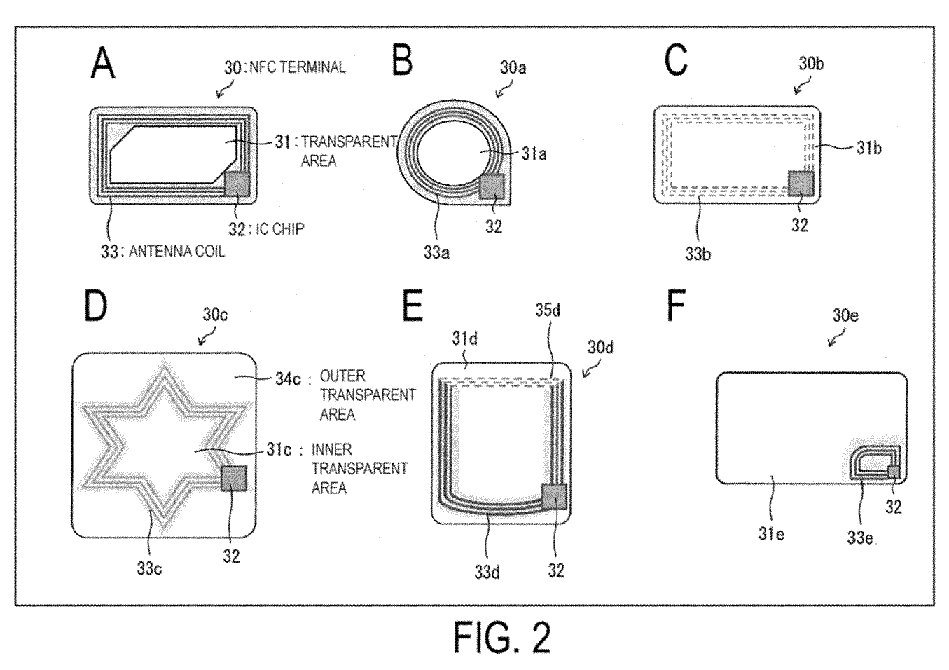

First, an NFC terminal 30 (terminal device) according to the present embodiment will be described with reference to FIG. 2. FIG. 2 is a diagram illustrating specific examples of the NFC terminal 30.

As illustrated in A of FIG. 2, the NFC terminal 30 according to the present embodiment is a rectangular card-shaped terminal and is able to transmit and receive information by being brought into close proximity to an NFC antenna 113 (antenna) serving as a tag reader. The NFC terminal 30 may include an IC chip 32 and an antenna coil 33. Note that the IC chip 32 and the antenna coil 33 are similar or identical to IC chips and antenna coils provided in existing card-shaped NFC terminals; thus, the descriptions of the IC chip 32 and the antenna coil 33 will be omitted.

The NFC terminal 30 further includes a transparent area 31 (light-transmitting portion) that passes light to through its center, thereby allowing at least a port of an image displayed on the display unit of an interfacing NFC device to be visually recognized. In a case that the NFC terminal 30 is placed on the display unit 112 of the information processing device 1 (described below), the above-described configuration enables a user to visually recognize the image displayed in the area of the display unit 112 on which the transparent area 31 is located.

Note that the shape of the NFC terminal 30 is not limited to a rectangle. For example, the NFC terminal 30 may be a circular card-shaped terminal similar to the NFC terminal 30a illustrated in B of FIG. 2. Furthermore, the shape of the transparent area 31 is not limited to any specific shape and may be a circular shape as illustrated in B of FIG. 2.

Although the area of the NFC terminal 30 where the IC chip 32 and the antenna coil 33 are disposed is an opaque area, the NFC terminal 30 is not limited to this example. For example, as illustrated in C of FIG. 2, the use of a thinned antenna coil 33b may allow an area where the antenna coil 33b is disposed to be a transparent area (transparent area 31b).

Furthermore, as illustrated in D of FIG. 2, the transparent area 31 may occupy not only the inside area where the antenna coil 33 is disposed, but also the outside area. The antenna coil 33 is flexibly disposed in the NFC terminal 30 in a variety of shapes, which eliminates the need for the antenna coil 33 to have substantially the same shape as the shape of the NFC terminal 30, as illustrated in D of FIG. 2.

Furthermore, as illustrated in E of FIG. 2, the use of a thinned antenna coil 35d as a part of the antenna coil 33 may allow only a part of the area where the antenna coil 33 is disposed to be a part of the transparent area 31d. Such a thinned antenna coil 33 reduces the sensitivity thereof. In contrast, as illustrated in E of FIG. 2, the partially-thinned antenna coil 33 (that is, the area where the antenna coil 33 is disposed is partially made opaque) can minimize the reduction in the sensitivity.

Further, the NFC terminal 30 is not limited to the example in which the area enclosed by the antenna coil serves as the transparent area 31. For example, as illustrated in F of FIG. 2, the IC chip 32 and the antenna coil 33e may be disposed at the lower right of an NFC terminal 30e, so that an area other than the area where the IC chip 32 and the antenna coil 33 are disposed serves as a transparent area 31e.

As described above, a plurality of variations are applicable to the NFC terminal 30 having the transparent area 31. Note that, provided that the NFC terminal 30 has the transparent area 31, the NFC terminal 30 is not limited to a card-shaped terminal. For example, the NFC terminal 30 may be a box-type terminal which is greater in thickness than the card-shaped terminal.

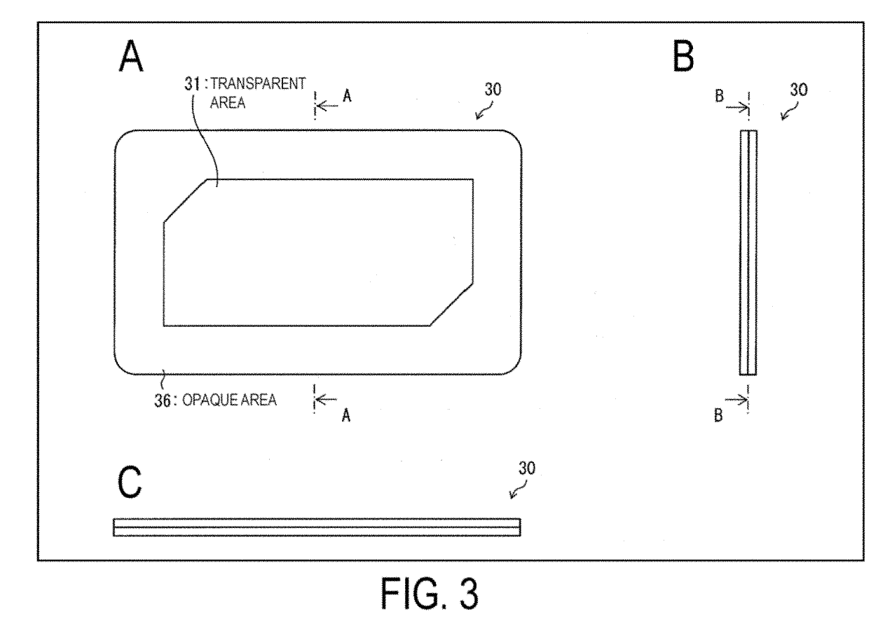

FIG. 3 is a diagram illustrating each face of the NFC terminal 30 as an orthographic drawing. A of FIG. 3 is a front view of the NFC terminal 30, B of FIG. 3 is a right-side view of the NFC terminal 30, and C of FIG. 3 is a bottom view of the NFC terminal 30. Note that, as the rear view is symmetrical with the front view, the rear view will be omitted. Also, as the left-side view and the plan view are the same shape as the right-side view and the bottom view, respectively, the left-side view and the plan view will be omitted.

The NFC terminal 30 illustrated in FIG. 3 is similar in size (54 mm×85 mm) to existing card-shaped terminals and has a thickness of from 1 mm to 2 mm; preferably about 1 mm. Also, as illustrated in B and C of FIG. 3, the NFC terminal 30 may be formed by two card-shaped plates pasted together, with the IC chip 32 and the antenna coil 33 formed in between the plates.

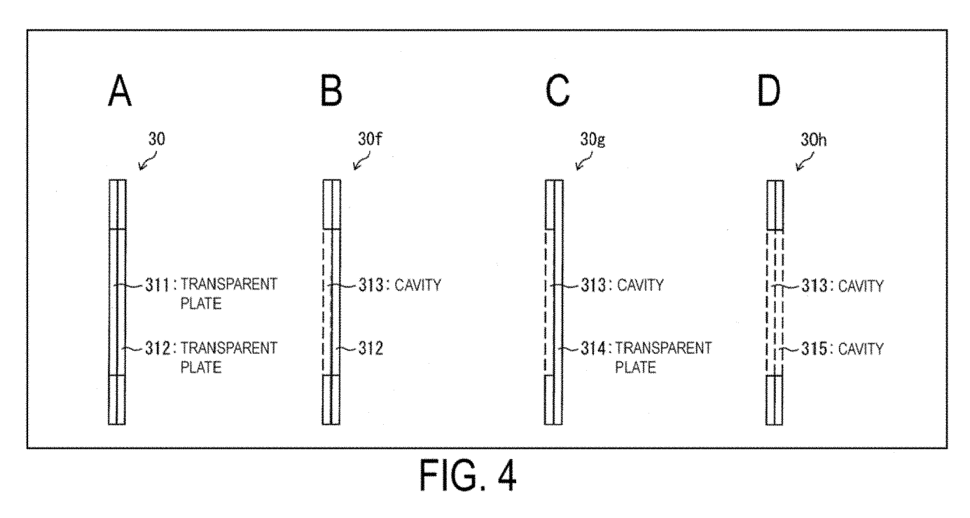

FIG. 4 is a cross-sectional view, taken along A-A, of the NFC terminal 30 illustrated in A of FIG. 3. As illustrated in A of FIG. 4, the transparent area 31 of the NFC terminal 30 may be formed by a transparent plate 311 and a transparent plate 312. Note that the configuration of the transparent area 31 is not limited to the example illustrated in A of FIG. 4. For example, the transparent area 31 may be formed by the transparent plate 312 and a cavity 313 as illustrated in B of FIG. 4.

Alternatively, as illustrated in C of FIG. 4, one of the card-shaped plates may be a transparent plate 314, the entirety of which is transparent. Note that, although the transparent area 31 of the other card-shaped plate is defined by the cavity 313 in the example illustrated in C of FIG. 4, the transparent area 31 may be formed by the transparent plate 311.

Alternatively, as illustrated in D of FIG. 4, the transparent area 31 may be formed by two card-shaped plates pasted together, each of which has a cavity. In other words, the transparent area 31 may be composed only of a cavity.

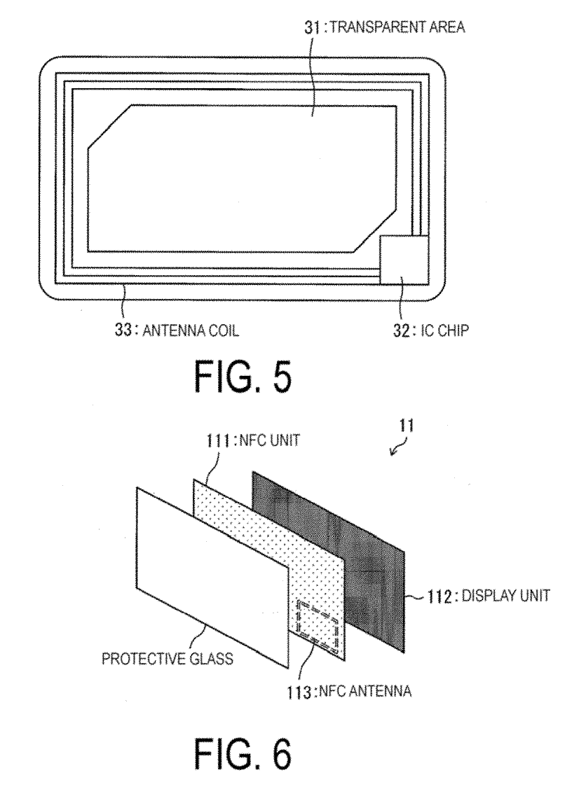

FIG. 5 is a cross-sectional view, taken along B-B, of the NFC terminal 30 illustrated in B of FIG. 3. As described above, the IC chip 32 and the antenna coil 33 may be formed between two card-shaped plates.

Note that although the NFC terminal 31 illustrated in FIGS. 3 to 5 may include the IC chip 32 and the antenna coil 33 formed between two card-shaped plates as described above, the NFC terminal 30 is not limited to the example illustrated in FIG. 3. For example, an NFC terminal may be formed by a single card-shaped plate and a sheet (seal) which has the IC chip 32 and the antenna coil 33 formed thereon and is attached to the card-shaped plate.

As described above, the NFC terminal 30 according to the present embodiment may include the transparent area 31. In a case that a user places the NFC terminal 30 on the NFC display 11 (display unit, described below) to establish Near field radio communication (also referred to herein as NFC) between the information processing device 1 (described below) and the NFC terminal 30, this configuration enables the user to visually recognize an image displayed at a location on which the transparent area 31 is located.

### Information Processing Device 1

Subsequently, the primary configuration of the information processing device 1 according to the present embodiment will be described with reference to FIG. 1. FIG. 1 is a block diagram illustrating an example of the primary configuration of the information processing device 1. The information processing device 1 includes, as one unit, a display device 10 configured to display images, and a control device 20 configured to control the display device 10. The information processing device 1 further includes an NFC display 11, an NFC control unit 12 (identification unit), a control unit 21, a storage unit 22, and a display drive unit 23 (display control unit).

Note that, in the information processing device 1, the display device 10 and the control device 20 may be separate units. In such a configuration, the display device 10 and the control device 20 may transmit and receive information via a communication unit (not illustrated). Note that the transmission and reception of information may be performed in a wired or wireless fashion. Furthermore, the display device 10 and the control device 20 may transmit and receive information via another device such as a router.

The NFC display 11 may be a display capable of Near field radio communication with an external device. The NFC display 11 may include an NFC unit 111 (communication unit) and a display unit 112. Note that NFC includes all types of short-range radio communication, and include, for example, Near field radio communication that uses RFID technology such as a non-contact IC card or a non-contact IC tag.

Here, a specific configuration of the NFC display 11 will be described with reference to FIG. 6. FIG. 6 is a diagram illustrating the specific configuration of the NFC display 11. As illustrated in FIG. 6, the NFC display 11 includes a protective glass, the NFC unit 111, and the display unit 112 which are layered in that order from the outermost portion.

The NFC unit 111 serves as a communication device configured to establish Near field radio communication with external devices. The NFC unit 111 includes an NFC antenna 113 which is a transparent antenna serving as a tag reader capable of detecting NFC tags (NFC terminals 30), and transmitting and receiving information. Specifically, as illustrated in FIG. 6, the NFC unit 111 is a sheet-shaped member provided in between the protective glass and the display unit 112. Note that, as illustrated in FIG. 6, although the NFC unit 111 according to the present embodiment includes one NFC antenna 113, the number, size, and position of the NFC antenna 113 are not limited to the example illustrated in FIG. 6.

The display unit 112 serves as a display device configured to display, as an image in a display area, information to be processed by the information processing device 1. The display unit 112 is a Liquid Crystal Display (LCD), for example, but is not limited to this example.

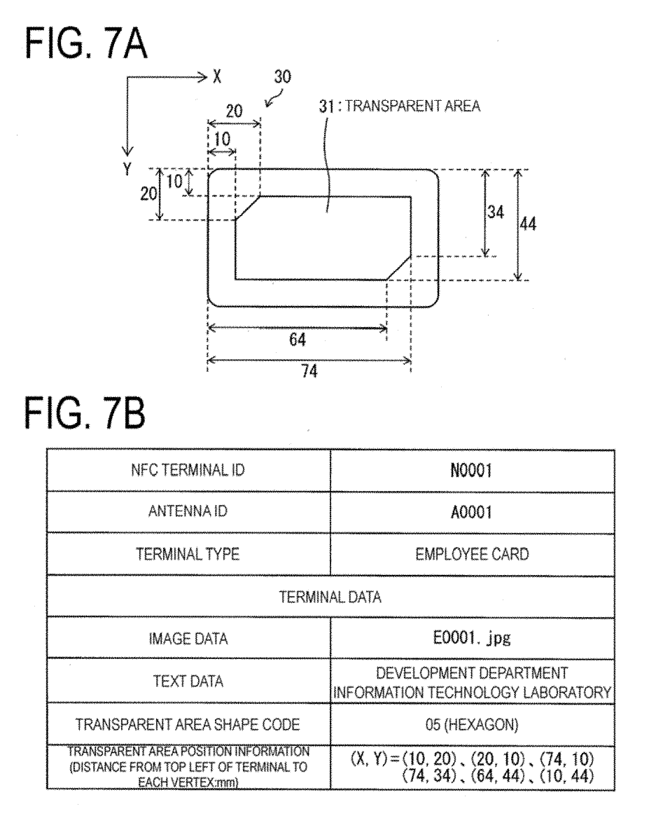

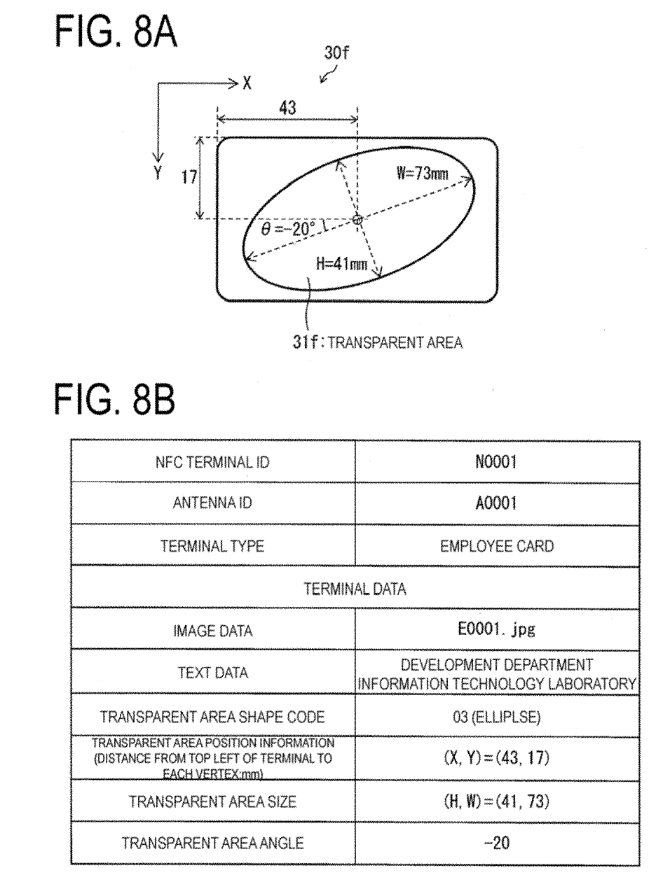

The NFC control unit 12 controls the NFC unit 111. Specifically, the NFC control unit 12 sets the NFC antenna 113 to an NFC enabled state (active) or an NFC disabled state (non-active) in accordance with instructions from the application execution unit 211 (area identification unit, terminal position identification unit) to be described below. Furthermore, the NFC control unit 12 generates NFC information from the information (terminal information) acquired by the NFC unit 111. Herein, the details of the NFC information will be described with reference to FIGS. 7A to 8B. FIG. 7A is a diagram illustrating an example of the NFC terminal 30, and FIG. 7B is a diagram illustrating a specific example of the NFC information acquired from the NFC terminal 30 illustrated in FIG. 7A. Furthermore, FIG. 8A is a diagram illustrating another example of the NFC terminal 30 (NFC terminal 30f), and FIG. 8B is a diagram illustrating a specific example of NFC information acquired from the NFC terminal 30f illustrated in FIG. 8A. Note that, in the present embodiment, an example will be described in which the NFC terminal 30 and the NFC terminal 30f serve as employee cards having NFC functionality. Furthermore, the NFC information is not limited to the examples illustrated in FIG. 7B and FIG. 8B.

The NFC unit 111 acquires an NFC terminal ID for identifying an NFC terminal from an employee card, a terminal type indicating the type of the NFC terminal, and terminal data stored in the NFC terminal, by the Near field radio communication via the NFC antenna 113.

In response to acquiring the NFC terminal ID, the terminal type, and the terminal data from the NFC unit 111, the NFC control unit 12 identifies an antenna ID for identifying the NFC antenna 113 via which the NFC terminal ID, the terminal type, and the terminal data have been acquired. Note that, only one NFC antenna 113 is provided in the present embodiment, which allows only one antenna ID to be used. Then, the information acquired from the NFC unit 111 and the antenna ID may be associated with each other to generate NFC information.

The terminal data in the example illustrated in FIG. 7B may include image data, text data, a transparent area shape code, and transparent area position information. The image data may be data of a photograph including the face of the user who owns the employee card. The text data may be textual data that indicates the affiliation of the user, but is not limited to this example. The transparent area shape code includes information indicating the shape of a transparent area on the employee card. Specifically, the shape of a transparent area is the shape of an area where an image displayed in the area of the NFC display 11 on which the employee card is located is visible in a case that the user places the employee card on the NFC display 11. In the example of FIG. 7B, the transparent area shape code is “05” (hexagon). The transparent area position information includes information for specifying the size of the transparent area and the position of the transparent area in the NFC terminal 30. In the example of FIG. 7B, the transparent area position information includes the XY-plane coordinates of each vertex of the transparent area in a case that the origin is set to the top left vertex of the employee card. In other words, the transparent area position information includes the distance (in units of mm) in the X direction and the Y direction from the origin to each vertex.

Note that the information for specifying the size of the transparent area and the position of transparent area in the NFC terminal is not limited to the transparent area position information. For example, as illustrated in FIG. 8A, in a case that the transparent area 31f of the NFC terminal 30f is an oblique ellipse, the terminal data further includes a transparent area size and a transparent area angle.

To describe the terminal data of the example of FIG, 8B in more detail, the transparent area shape code may be “03” (ellipse). Also, the transparent area position information in the example of FIG. 8B includes the XY-plane coordinates at the center point of the transparent area 31f in a case that the origin is set to the top let vertex of the employee card. In other words, the transparent area position information includes the distance (in units of mm) in the X direction and the Y direction from the origin to the center point of the transparent area 31f. That is, the transparent area position information in the example of FIG. 89 includes information for identifying the center point of the transparent area 31f.

In addition, the transparent area size is information indicating the size of the transparent area, and in the example of FIG. 8B, the transparent area size is information indicating the length of the major axis and minor axis of the transparent area 31f. Note that, the transparent area size changes depending on the shape of the transparent area; thus, the transparent area size is not limited to the example of FIG. 8B.

In addition, the transparent area angle includes information indicating the inclination of the transparent area with respect to the NFC terminal. More particularly, the transparent area angle includes information indicating an angle formed between an axis set for the terminal device and an axis which is on the same plane as that axis and is determined based on the shape of the transparent area.

Hereinafter, unless otherwise specified, a description will be given under the assumption that the NFC terminal is the NFC terminal 30 illustrated in FIGS. 7A and 7B. In addition, the transparent area shape code and information for specifying both the size of the transparent area and the position in the NFC terminal may be collectively referred to as transparent area information.

The NFC control unit 12 outputs the generated NFC information to the application execution unit 211. In FIGS. 7A to 8B, although the NFC terminal ID and the antenna ID are composed of alphabetical characters and numeric characters, the invention is not limited to this example.

The control unit 21 collectively control the functions of the information processing device 1, and particularly the functions of the control device 20. The control unit 21 includes the application execution unit 211 and an image generation unit 212.

The application execution unit 211 may execute various applications included in the information processing device 1. Specifically, in a case that the application execution unit 211 acquires information, from an operation unit (not illustrated), indicating an operation to launch an application, the application execution unit 211 executes an application 221 from among the applications 221 stored in the storage unit 22 based on the acquired information. Next, the image generation unit 212 is instructed to generate an image, Specifically, the application execution unit 211 references the NFC terminal information 222 and the antenna position information 223 (communication position information) stored in the storage unit 22, and instructs the image generation unit 212 to generate a guide image having substantially the same shape and size as the proximity surface (a surface to be brought into proximity to the NFC antenna 113) of the NFC terminal 30.

Here, the NFC terminal information 222 includes information indicating the shape and size of the proximity surface of the NFC terminal 30. That is, in the present embodiment, the shape and size of the proximity surface of the NFC terminal 30 to be used are pre-stored in the storage unit 22. The NFC terminal information 222 is associated with information for identifying the application 221. This configuration enables the application execution unit 211 to read out appropriate NFC terminal information 222 corresponding to the executed application 221. For example, in a configuration in which the NFC terminal 30 is a rectangular employee card, the NFC terminal information 222 includes information that indicates the shape of the employee card (for example, a two-digit number indicating the shape), and the lengths of the short side and long side of the employee card. However, as the NFC terminal information 222 varies depending on the shape and size of the proximity surface of the NFC terminal 30, the invention is not limited to this example.

In addition, the antenna position information 223 includes information indicating the position of the NFC antenna 113 in the NFC unit 111. Specifically, the antenna position information 223 includes information in which the antenna ID for identifying the NFC antenna 113 and the information indicating the position of the NFC antenna 113 are associated with each other. In a case that the NFC antenna 113 is rectangular, the information indicating the position of the NFC antenna 113 may, for example, include the XY-plane coordinates, based on the display resolution, of the top left and bottom right vertices of the NFC antenna 113 in a case that the top left vertex of the image display area of the display unit 112 is set as the origin, or the XY-plane coordinates, based on the display resolution, of the center point of the NFC antenna 113, but the invention is not limited to these examples.

In addition, the guide image is an image for informing the user of the position to which the NFC terminal 30 is brought into proximity. The application execution unit 211 instructs the image generation unit 212 to generate a guide image having substantially the same size and shape as the size and shape of the proximity surface of the NFC terminal 30 indicated by the NFC terminal information 222, and display the guide image in the area of the display unit 112 corresponding to the position indicated by the antenna position information 223.

In addition, the application execution unit 211 instructs the NFC control unit 12 to activate or deactivate the NFC antenna 113.

Further, in response to acquiring the NFC information from the NFC control unit 12, the application execution unit 211 references the transparent area information included in the NFC information, the NFC terminal information 222, and the antenna position information 223 to identify the area of the display unit 112 corresponding to the transparent area of the NFC terminal 30. Specifically, at the position indicated by the antenna position information 223, the application execution unit 211 identifies the area of the display unit 112 corresponding to the proximity surface of the NFC terminal 30 indicated by the NFC terminal information 222. Here, in a case that the NFC terminal 30 is a rectangular employee card, an XY plane with an origin set to the top left vertex of the identified area is virtually formed. Next, coordinates in the transparent area position information on the XY plane (XY-plane coordinates based on the display resolution) are identified. Subsequently, the application execution unit 211 instructs the image generation unit 212 to generate an image matching the shape and size of the area indicated by the identified coordinates, and display the image in the identified area. This image includes an image generated in response to the establishment of NFC between the NFC terminal 30 and the information processing device 1. In a case that the NFC terminal 30 is an employee card, the image includes an image indicated by the image data included in the employee card and the text indicated by the text data (see FIG. 7B). Note that a specific example of the application 221 according to the present embodiment will be described below.

The image generation unit 212 generates an image in accordance with the instruction from the application execution unit 211. For example, the image generation unit 212 generates a guide image having a shape and size indicated by the application execution unit 211, or generate an image having a shape and size of an area of the display unit 112 corresponding to the transparent area of the NFC terminal 30 indicated by the application execution unit 211. The image generation unit 212 outputs the generated image to the display drive unit 23, and also output the display position indicated by the application execution unit 211 to the display drive unit 23.

The display drive unit 23 controls the display unit 112. Specifically, the display drive unit 23 displays the image acquired from the image generation unit 212 at the display position acquired from the image generation unit 212.

The storage unit 22 stores various types of data used by the information processing device 1. The storage unit 22 stores at least the application 221, the NFC terminal information 222, and the antenna position information 223. Note that, as the application 221, the NFC terminal information 222, and the antenna position information 223 have already been described, the descriptions thereof will be omitted.

### Processing Flow Executed by Information Processing Device 1

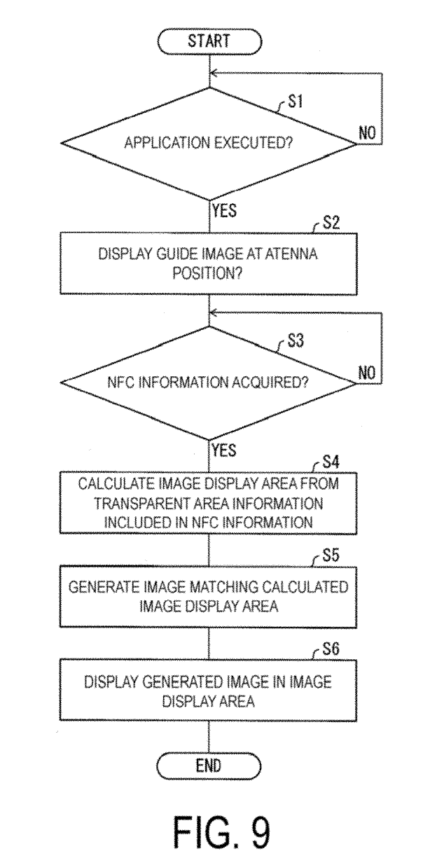

Next, a processing flow executed by the information processing device 1 will be described with reference to FIG. 9. FIG. 9 is a flowchart illustrating an example of a processing flow executed by the information processing device 1.

First, the application execution unit 211 waits for information indicating the execution of the application, more specifically, an operation for executing the application (S1). In a case that the application is executed (YES in S1), the information processing device 1 causes the guide image to be displayed at the position of the NFC antenna 113 (S2). Specifically, the application execution unit 211 instructs the image generation unit 212 to generate a guide image having substantially the same size and shape as the size and shape of the proximity surface of the NFC terminal 30 indicated by the NFC terminal information 222, and display the guide image in the area of the display unit 112 corresponding to the position indicated by the antenna position information 223. The image generation unit 212 generates a guide image having the shape and size indicated by the application execution unit 221, and outputs the position indicated by the application execution unit 211 to the display drive unit 23. The display drive unit 23 displays the guide image acquired from the image generation unit 212 at the display position acquired from the image generation unit 212.

Subsequently, the application execution unit 211 enters a standby state to wait for the NFC information (S3). In response to acquiring the NFC information from the NFC control unit 12 (YES in S3), the application execution unit 211 calculate the image display area from the transparent area information included in the NFC information (S4, area identification step). Specifically, the application execution unit references the transparent area information included in the NFC information., as well as the NFC terminal information 222 and the antenna position information 223 stored in the storage unit 22 to identify the area of the display unit 112 corresponding to the transparent area of the NFC terminal 30. Then, the image generation unit 212 is instructed to generate an image matching the identified area (calculated image display area), and display the image in the identified area.

The image generation unit 212 generates an image matching the image display area calculated by the application execution unit 211 (S5). Next, the image generation unit 212 outputs the generated image and the display position (image display area) indicated by the application execution unit 211 to the display drive unit 23.

Finally, the display drive unit 23 causes the generated image to be displayed in the image display area (S6, display control step). In this step, the processing executed by the information processing device 1 is terminated.

### Example of Application

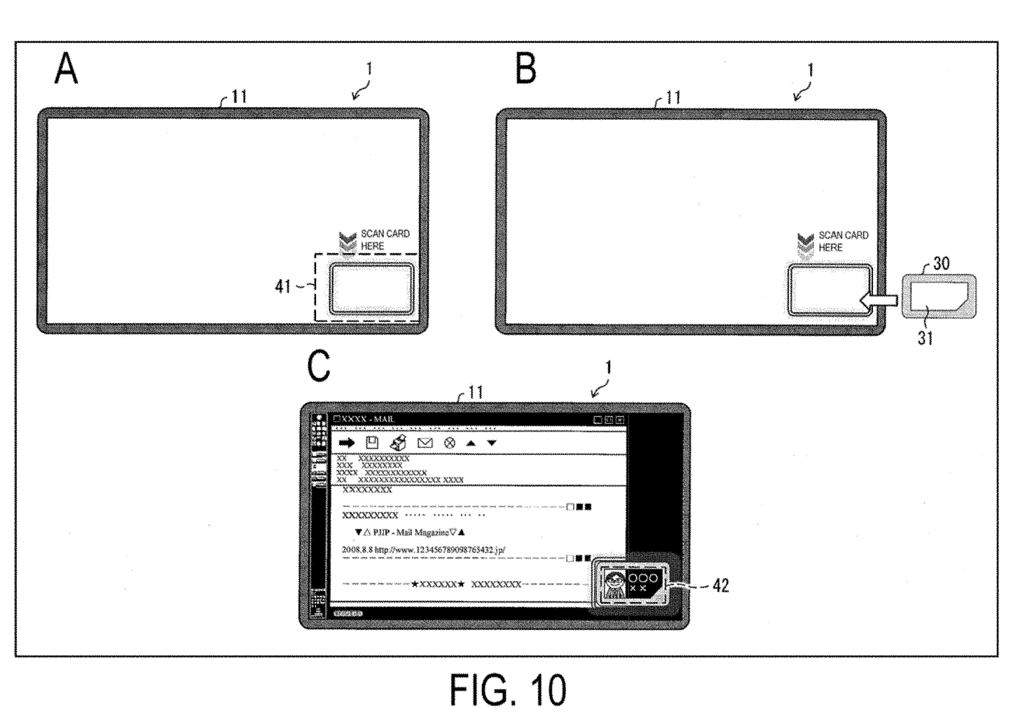

Next, an example of the application 221 executed by the information processing device 1 according to the present embodiment will be described with reference to FIG. 10. FIG. 10 is a transition diagram illustrating the information processing device 1 according to the present embodiment executing the application 221.

The application 21 illustrated in FIG. 10 serves as an authentication application for logging in to the information processing device 1. Note that this application 221 is an example, and the application executed by the information processing device 1 according to the present embodiment is not limited to this example.

A of FIG. 10 illustrates an NFC display 11 in a state before the employee card that is the NFC terminal 30 is brought into proximity to the NFC antenna 113. As illustrated in A of FIG. 10, a guide image 41 having substantially the same shape and size as the employee card is displayed on the display unit 112.

As illustrated in B of FIG. 10, a user places the employee card on the NFC display 11 in accordance with the guide image 41. This causes the NFC control unit 12 to acquire information held in the employee card, generate NFC information, and output the NFC information to the application execution unit 211.

Subsequently, the application execution unit 211 calculates the image display area from the transparent area information included in the NFC information, and outputs this image display area information as well as the image data and text data included in the NFC information to the image generation unit 212. This causes the image generation unit 212 to generate an image that includes both a photograph of the user who owns the employee card and text (affiliation, name, and the like) related to the user. As illustrated in C of FIG. 10, this image has substantially the same shape and size as the image display area; that is, the same as the transparent area 31 of the employee card.

Note that the application execution unit 211 also performs user authentication. As the user authentication process has little connection to the invention, the detailed description of the user authentication process will be omitted. For example, the information held in the employee card includes information for identifying the user, and, in response to acquiring the information, the application execution unit 211 performs user authentication and identification by referencing information (not illustrated), stored in the storage unit 22, for identifying each employee. In response to completion of user authentication and identification, the application execution unit 211 instructs the image generation unit 212 to generate an image (for example, an image of a wallpaper set by the user) based on the identified user. The image generation unit 212 generates the image in accordance with the instruction.

Finally, as illustrated in C of FIG. 10, the display drive unit 23 that has acquired the image generated by the image generation unit 212 displays the image.

### Second Embodiment

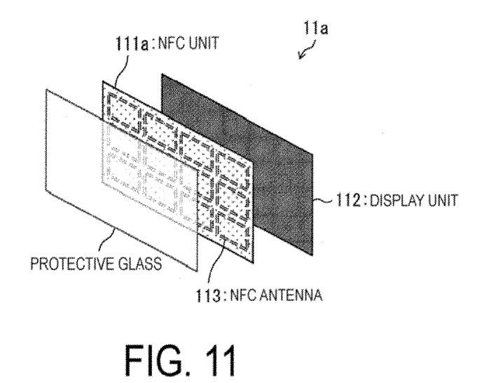

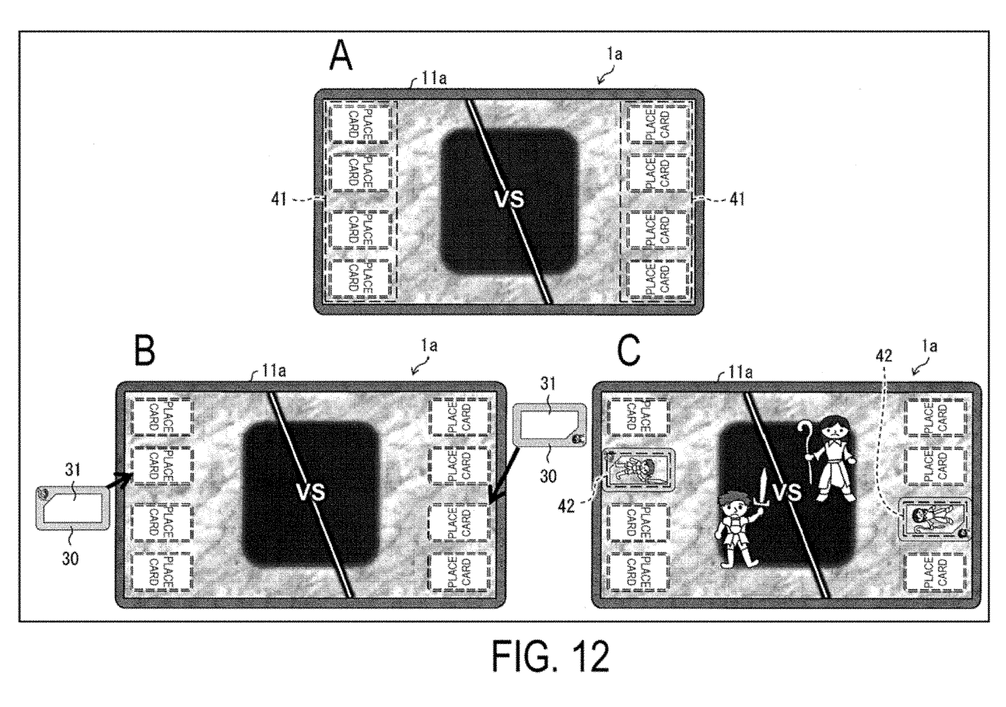

Other embodiments of the invention will be described in the following with reference to FIG. 11 and FIG. 12. Note that, for convenience of explanation, components illustrated in respective embodiments are designated by the same reference numerals as those having the same function, and the descriptions of these components will be omitted.

FIG. 11 is a diagram illustrating a specific configuration of an NFC display 11a included in an information processing device 1a according to the present embodiment. In contrast to the NFC display 11 described in the first embodiment, the NFC display 11a includes an NFC unit 111a. Further, unlike the NFC unit 111 described in the first embodiment, the NFC unit 11a includes a plurality of NFC antennas 113. Note that, although the plurality of NFC antennas 113 are arranged in a matrix in the NFC unit 111a illustrated in FIG. 11, the number and arrangement of the NFC antennas 113 are not limited to the example illustrated in FIG. 11. Note that different antenna IDs are set for each of the plurality of NFC antennas 113 according to the present embodiment.

Note that, as the information processing device 1a is substantially similar to the information processing device 1 described in the first embodiment with the exception that the NFC display 11a is provided in place of the NFC display 11, a block diagram illustrating a primary configuration of the information processing device 1a and the description of each component will be omitted in the present embodiment.

### Example of Application

Next, an example of an application 221a executed by the information processing device 1a according to the present embodiment will be described with reference to FIG. 12. FIG. 12 is a transition diagram illustrating the information processing device 1a according to the present embodiment executing the application 221a.

The application 221a illustrated in FIG. 12 serves as an application for a competitive card game between two users. Note that this application 221a is provided as an example, and the application executed by the information processing device 1a according to the present embodiment is not limited to this example.

First, the NFC control unit 12 receives an instruction from the application execution unit 211, and activate, of the plurality of NFC antennas 113, NFC antennas 113 in the leftmost column and NFC antennas 113 in the rightmost column of A of FIG. 12. Next, the application execution unit 211 instructs the image generation unit 212 to generate the guide image 41 to be displayed at the position of the activated NFC antenna. Subsequently, the display drive unit 23 causes the display unit 112 to display the image (including the guide image 41) generated by the image generation unit 212. As illustrated in A of FIG. 12, this causes the image of the application 221a, including the guide image 41, to be displayed on the display unit 112.

Next, as illustrated in B of FIG. 12, each user places his or her NFC terminal 30 (hereinafter referred to as a card) on the NFC display 11a in accordance with the guide image 41. This causes Near field radio communication to be established between the card and the information processing device 1a, and then causes information (for example, an image of a character indicated by the card, and status) held in the card to be transmitted to the information processing device 1a. Next, the NFC control unit 12 generates NFC information including the received information, and outputs the NFC information to the application execution unit 211.

Subsequently, the application execution unit 211 calculates the image display area from the transparent area information included in the NFC information, and output both the image display area information and the image data of the character included in the NFC information to the image generation unit 212. This causes the image generation unit 212 to generate an image of the character indicated by the card. As illustrated in C of FIG. 12, this image is an image 42 having a size equal to or smaller than the size of the image display area, that is, a size equal to or smaller than the size of the transparent area 31 of the card. Note that the image generation unit 212 adjusts the size of the image of the character as necessary so that the image fits within the transparent area 31.

Furthermore, as illustrated in C of FIG. 12, the image generation unit 212 generates an image of a character to be displayed in the vicinity of the center of the display unit 112 in accordance with an instruction from the application execution unit 211.

Finally, as illustrated in C of FIG. 12, the display drive unit 23 which has acquired the image generated by the image generation unit 212 displays the image.

Note that, in the example illustrated in FIG. 12, although only the image of the character is displayed as the image 42, the image 42 may include other information such as the status of the character. Furthermore, other information such as the status of the character may be displayed in the periphery of the card,

Furthermore, in a case that terminal data such as the status of the character changes in accordance with the progress of the card game, the NFC control unit 12 may transmit the changed terminal data to the card using NFC. The information transmitted to the card is limited to the status of the character, but may include, for example, a win-loss record.

### Modifications of the First and Second Embodiments

In the first and second embodiments, although a configuration has been described in which the information processing device 1 (or the information processing device 1a) acquires the transparent area information from the NFC terminal 30 by Near field radio communication, another configuration may be employed in the application 221, in which the transparent area information is pre-stored in the information processing device 1 in a case that only NFC terminals 30 having the same transparent area information are used. In such a configuration, the transparent area information and the information for identifying the application 221 are stored being associated with each other, and, in response to acquiring the NFC information, the application execution unit 211 read outs transparent area information corresponding to a running application 221, the NFC terminal information 222, and the antenna position information 223, and identify an image display area.

In the first and second embodiments described above, a configuration has been described in which the information processing device 1 (or the information processing device 1a) pre-stores information (NFC terminal information 222) indicating the shape and size of the NFC terminal 30 in the storage unit 22. However, the information indicating the shape and size of the NFC terminal 30 need not be pre-stored in the storage unit 22. Specifically, the information processing device 1 (or the information processing device la) may acquire the information from the NFC terminal 30 by Near field radio communication.

In this example, in addition to the various types of data illustrated in FIG. 7B and FIG. 8B, the NFC information further includes information indicating the shape and size of the NFC terminal 30 as terminal data. The information has no particular limitation, and, for example, in a case that shape of the NFC terminal 30 is a rectangle, information indicating that the shape of the NFC terminal 30 is a rectangle (for example, a two-digit number indicating the shape) and information indicating the length of the long and short sides of the NFC terminal 30 may be used.

Furthermore, in this example, the storage unit 22 further stores information indicating the shape and size of the antenna instead of the NFC terminal information 222, and the application execution unit 211 references this information and the antenna position information 223 and instructs the image generation unit 212 to generate a guide image having substantially the same shape and size as the proximity surface of the NFC terminal 30 (the surface to be brought into proximity to the NFC antenna 113).

### Third Embodiment

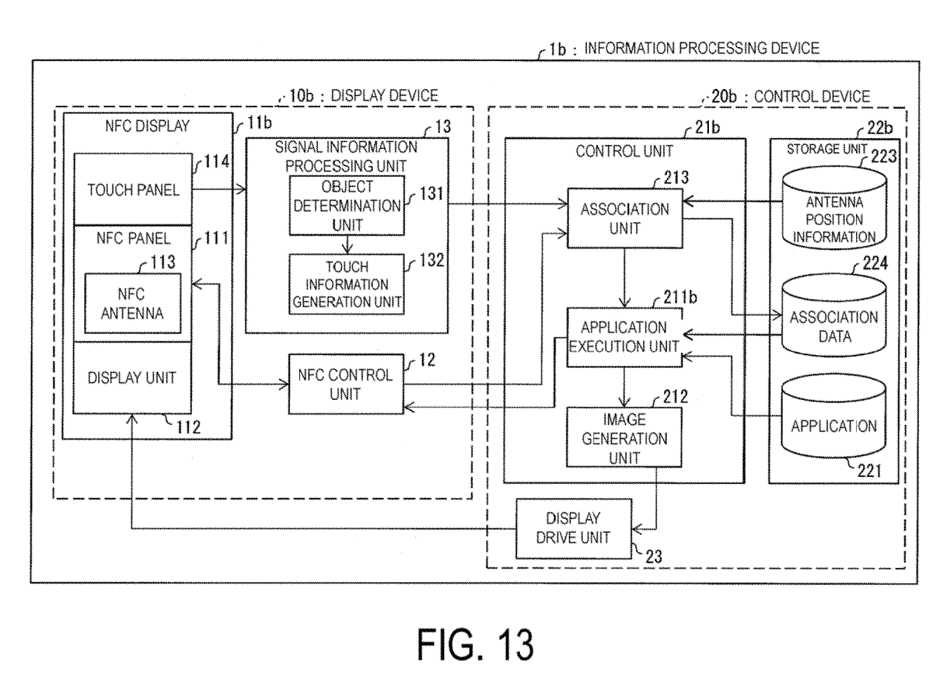

Still another embodiment of the invention will be described with reference to FIGS. 13 to 21. Note that, for convenience of explanation, components illustrated in respective embodiments are designated by the same reference numerals as those having the same function, and the descriptions of these components will be omitted.

FIG. 13 is a block diagram illustrating an example of a primary configuration of an information processing device 1b according to the present embodiment. In the information processing device 1b, a display device 10b for displaying images and a control device 20b for controlling the display device 10b are integrated as one unit. Note that, in the information processing device 1b, the display device 10b and the control device 20b may be separate units. In such a configuration, the display device 10b and the control device 20b transmits and receives information via a communication unit (not illustrated). Note that the transmission and reception of information may be performed in a wired or wireless fashion. Furthermore, the display device 10b and the control device 20b may transmit and receive information via another device such as a router.

In contrast to the information processing device 1 described in the first embodiment, the information processing device 1b includes an NFC display 11b, a control unit 21b, and a storage unit 22b in place of the NFC display 11, the control unit 21, and the storage unit 22, respectively. Furthermore, the information processing device 1b additionally includes a signal information processing unit 13.

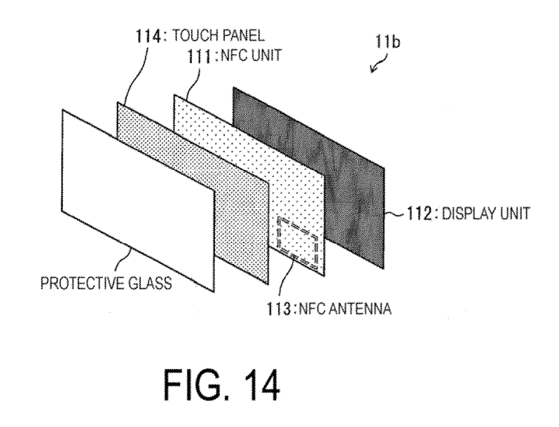

The NFC display 11b additionally includes a touch panel 114. Here, a specific configuration of the NFC display 11b will be described with reference to FIG. 14. FIG. 14 is a diagram illustrating a specific configuration of the NFC display 11b. As illustrated in FIG. 14, the NFC display 11b includes a protective glass, the touch panel 114, the NFC unit 111, and the display unit 112 which are stacked in that order from the outermost portion.

The touch panel 114 includes a touch surface configured to receive contact with an object, and a touch sensor configured to detect contact between a pointer and the touch surface and to sense a position of input made by the contact. The touch sensor may be implemented with any sensor, provided the sensor is capable of detecting contact/non-contact between the pointer and the touch surface. For example, the touch sensor may be implemented with a pressure sensor, a capacitive sensor, a light sensor, or the like. Note that, in the present embodiment, a description will be given under the assumption that the touch sensor is a capacitive sensor. In addition, the touch panel 114 may be configured to detect a so-called “proximity state” in which an object is not in contact with the touch panel 114, but the distance between the touch panel 114 and the object is within a predetermined distance.

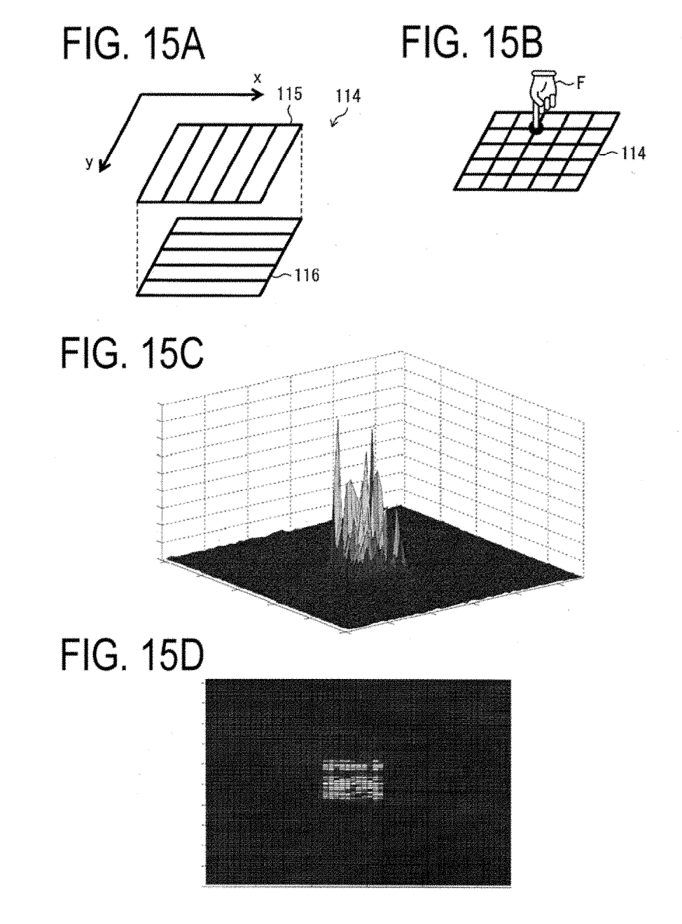

Here, details of the touch panel 114 including the capacitive sensor will be described with reference to FIGS. 15A to 15D. FIGS. 15A and 15B are diagrams for explaining the principles of the touch panel 114, and FIGS. 15C and 15D are diagrams illustrating an example of a sensor signal generated in a case that an object comes into contact with the touch panel 114.

As illustrated in FIG. 15A, the touch panel 114 is formed of a transparent electrode 115 extending in the Y direction and a transparent electrode 116 extending in the X direction which are layered. Next, as illustrated in FIG. 15B, the capacitance changes in a case that an object having conductivity (finger F of FIG. 15B) comes into contact with the touch panel 114. At this time, by detecting which of the electrodes for which the capacitance has changed, it is possible to identify the coordinates with which the object comes into contact.

FIGS. 15C and 15D are diagrams illustrating an example of a sensor signal indicating the amount of change in the capacitance in a case that an object such as a card having NFC functionality is brought into contact with the touch panel 114. Note that the card having NFC functionality includes an antenna coil for enabling NFC functionality, and the conductivity of the antenna coil enables the touch panel 114 to detect contact of the card.

In a case that the card is brought into contact with the touch panel 114, a sensor signal (position information) as illustrated in C of FIG. 3 is generated. When illustrated as a top view, as illustrated in D of FIG. 3, it can be seen that the sensor signal is generated in the shape of the contact surface of the card (the surface in contact with the touch panel 114). Specifically, a sensor signal having a shape corresponding to the shape of the antenna coil is generated. Note that, in a case that the terminal (NFC terminal) with NFC functionality itself has conductivity, a sensor signal having a shape corresponding to the shape of the terminal is generated. The touch panel 114 outputs signal information indicating the sensor signal to the signal information processing unit 13. Specifically, the touch panel 114 outputs the signal information to the signal information processing unit 13 at a frequency of from 60 to 240 times per second.

Note that, although not illustrated, in a case that a pointer such as a finger comes into contact with the touch panel 114, a wide-range sensor signal (in other words, a broad sensor signal) like that of FIG. 15C is not generated, but a narrow-range sensor signal (in other words, a narrow sensor signal) is generated.

Although a configuration in which the NFC unit 111 and the touch panel 114 are separate units has been described in the present embodiment, the NFC unit 111 and the touch panel 114 may be integrated as one unit. For example, a configuration in which the NFC antenna 113 is provided on the touch panel 114 may be employed. This also applies to the fourth embodiment (described below).

The signal information processing unit 13 may process the signal information acquired from the touch panel 114. The signal information processing unit 13 may include an object determination unit 131 and a touch information generation unit 132.

The object determination unit 131 may determine whether the object in contact with the touch panel 114 is a pointer such as a finger or pen, or an NFC terminal having NFC functionality (for example, the NFC terminal 30). Specifically, the object determination unit 131 determines whether the sensor signal indicated by the acquired signal information is a sensor signal generated in a wider range than a predetermined range. As described above, in a case that the sensor signal is generated in a wider range than the predetermined range, there is a high probability that the object is an NFC terminal. In contrast, in a case that the sensor signal is generated within the predetermined range, there is a high probability that the object is a pointer. The object determination unit 131 outputs the determination result to the touch information generation unit 132.

Note that the object determination unit 131 has only to be capable of determining whether the object in contact with the touch panel 114 is a pointer or an NFC terminal; thus, the object determination unit 131 is not limited to the above-described configuration in which the object determination unit 131 determines whether the sensor signal indicated by the acquired signal information is a sensor signal generated in a wider range than the predetermined range. For example, a configuration may be employed in which the object determination unit 131 determines whether the number of acquired sensor signals is greater than a predetermined number. In such a configuration, in a case that the number is larger than the predetermined number, there is a high probability that the object is an NFC terminal. In contrast, in a case that the number is less than the predetermined number, there is a high possibility that the object is a pointer.

The touch information generation unit 132 generates touch information based on the determination result of the object determination unit 131. In a case that the acquired determination result indicates that the acquired sensor signal is not a sensor signal generated in a wider range than the predetermined range, the touch information generation unit 132 identifies the coordinates (peak coordinates) where the strongest sensor signal is generated, associates the coordinates with a touch ID for identifying touch information, and generates the touch information.

In contrast, in a case that the acquired determination result indicates that the sensor signal is generated in a wider range than the predetermined range, the touch information generation unit 132 references the signal information and performs shape analysis on the sensor signal.

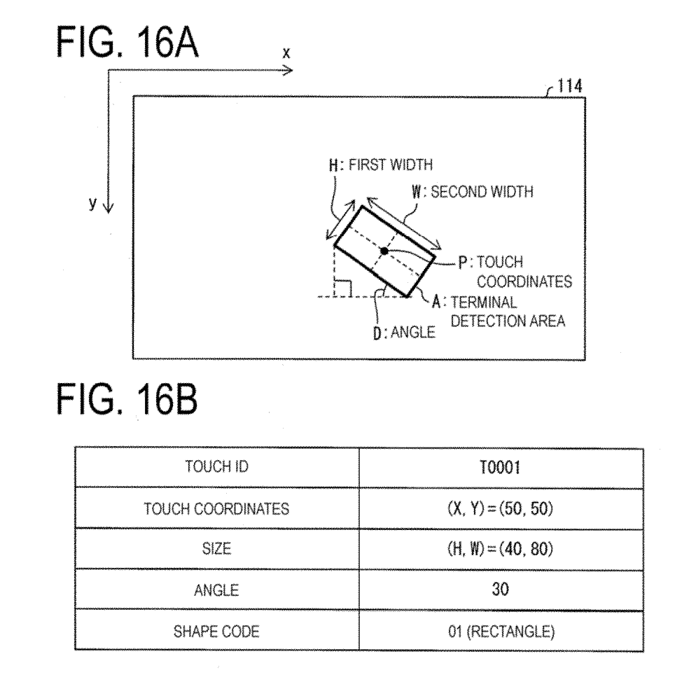

Here, the detailed description of the shape analysis and the touch information will be given with reference to FIGS. 16A and 16B. FIG. 16A is a diagram illustrating an example of each parameter of a terminal candidate area identified by shape analysis. FIG. 16B is a diagram illustrating a specific example of the touch information in a case that the object is a rectangular NFC terminal. Note that, as illustrated in FIG. 16A, the virtual XY plane may be preset on the touch panel 114. The touch information generation unit 132 identifies the terminal candidate area from the coordinates where the sensor signal has been generated. Subsequently, the outer edges of the terminal candidate area are corrected as illustrated in FIG. 16A, so that the outer peripheral shape of the terminal candidate area is defined. Next, the outer peripheral shape illustrated in FIG. 16A is identified (in the case of FIG. 16A, the outer peripheral shape is identified as a rectangle), and the center coordinates (hereinafter, touch coordinates), size, and inclination angle (hereinafter, angle) of the rectangle are calculated. Note that the “angle” refers to an angle formed between the X axis of the XY plane and an axis which is on the same plane as the X axis and is determined based on the outer peripheral shape of the terminal candidate area (in the example of FIG. 16A, the long side of the rectangle).

Note that the outer peripheral shape of the terminal candidate area is defined with reference to the information acquired from the NFC terminal via the NFC antenna 113, the information indicating the shapes and sizes of the NFC terminal and antenna coil.

Next, the touch information generation unit 132 associates the calculated touch coordinates, size, angle, and a shape code indicating the outer peripheral shape of the terminal candidate area with the touch ID, and generates the touch information as illustrated in FIG. 16B. The touch information generation unit 132 outputs the generated touch information to an association unit 213 (described below). Here, as illustrated in FIG. 16B, the shape code is a two-digit number associated with the outer peripheral shape of the terminal candidate area. Data associated with the outer peripheral shape and the shape code is pre-stored in the storage unit 22, and, for example, as illustrated in FIG. 16B, the shape code “01” is associated with a rectangle. Note that the association between the shape code and the shape is not limited to this example; for example, the shape code “02” may be associated with a circle, “03” may be associated with an ellipse, “04” may be associated with a triangle, and “05” may be associated with a hexagon. Further, combinations (associations) of shape codes and shapes, as well as the number of shape codes are not limited to the examples described herein. Note that although the touch ID is composed of alphabetical characters and numeric characters and the shape code is composed of a two-digit number in FIG. 16B, this is merely an example and the invention is not limited to this example. In addition, although the size shown in FIG. 16B is assumed to apply to an NFC terminal with an outer peripheral shape of a rectangle where H indicates the length of the short sides of the NFC terminal and W indicates the length of the long sides of the NFC terminal, the invention is not limited to this example.

Also, the types of information included in the touch information illustrated in FIG. 16B are merely examples, and the information is not limited to these examples. For example, “status information” indicating the state of the NFC terminal placed on the NFC display 11 may also be included. Here, specific examples of the “status information” may include “touch in” indicating that the NFC terminal has come into contact with the NFC display 11, “move” indicating that the NFC terminal is moving on the NFC display 11, “touch out” indicating that the NFC terminal has left the NFC display 11, and the like, but the invention is not limited to these examples.

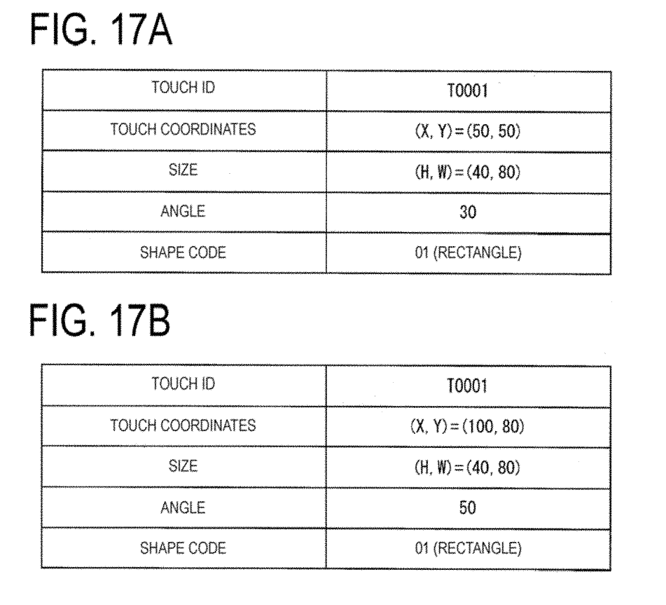

Note that the touch panel 114 continuously outputs signal information to the signal information processing unit 13 while the object is in contact with the object. The touch information generation unit 132 continuously generates touch information based on acquired signal information, and outputs the touch information to the association unit 213 (described below). At this time, the touch information generation unit 132 keeps assigning the same touch ID to the generated touch information until the output of the signal information from the touch panel is interrupted. This processing will be described with reference to FIGS. 17A and 17B. FIG. 17A is a diagram illustrating a specific example of touch information generated in a case that the NFC terminal comes into contact with the touch panel 114, and FIG. 17B is a diagram illustrating a specific example of touch information in a case that the NFC terminal is moving while in contact with the touch panel 114.

In a case that the NFC terminal comes into contact with the touch panel 114, the touch information generation unit 132 executes the above-described processing and generates the touch information illustrated in FIG. 17A. Subsequently, as the NFC terminal moves while in contact with the touch panel 114, the touch information generation unit 132 continuously generates touch information based on the acquired signal information. At this time, as the NFC terminal is moving, the touch coordinates included in the touch information change. For example, as illustrated in FIGS. 17A and 17B, the touch coordinates change from (X, Y)=(50, 50) to (X, Y)=(100, 80). Note that, actually, from after the generation of the touch information illustrated in FIG. 17A until the generation of the touch information illustrated in B of FIG. 5, a plurality of pieces of touch information including the touch coordinates corresponding to the movement trajectory are generated, but the pieces of touch information are omitted from FIGS. 17A and 17B for the sake of simplicity.

In contrast, in a case that the NFC terminal moves while in contact with the touch panel 114, the touch information generation unit 132 uses, as a touch ID of newly generated touch information, a touch ID of the touch information generated in a case that the NFC terminal comes into contact with the touch panel 114. Specifically, as illustrated in B of FIG. 5, T0001 is continuously used as the touch ID. Next, the touch information generation unit 132 outputs the generated touch information to the association unit 213 (described below).

In contrast to the control unit 21 described in the first embodiment, the control unit 21b includes an application execution unit 211b instead of the application execution unit 211. Furthermore, the control unit 21b includes the association unit 213.

The association unit 213 stores the touch information acquired from the signal information processing unit 13 and the NFC information acquired from the NFC control unit 12 with both the pieces of information associated with each other. Specifically, in response to acquiring touch information from the signal information processing unit 13, the association unit 213 determines whether the touch information is touch information indicating contact of a pointer or touch information indicating contact of an NFC terminal. Specifically, the association unit 213 determines whether the touch information includes specific information of the touch information indicating contact with the NFC terminal such as a size, angle, and shape code. Note that the above-described specific information is not limited to the above examples.

Here, in a case that the association unit 213 determines that the touch information indicates contact with a pointer, that is, the touch information does not include the specific information, the association unit 213 associate the contact indicated by the touch information with a pointer, and perform the subsequent processing. Specifically, the association unit 213 outputs the touch information to the application execution unit 211b.

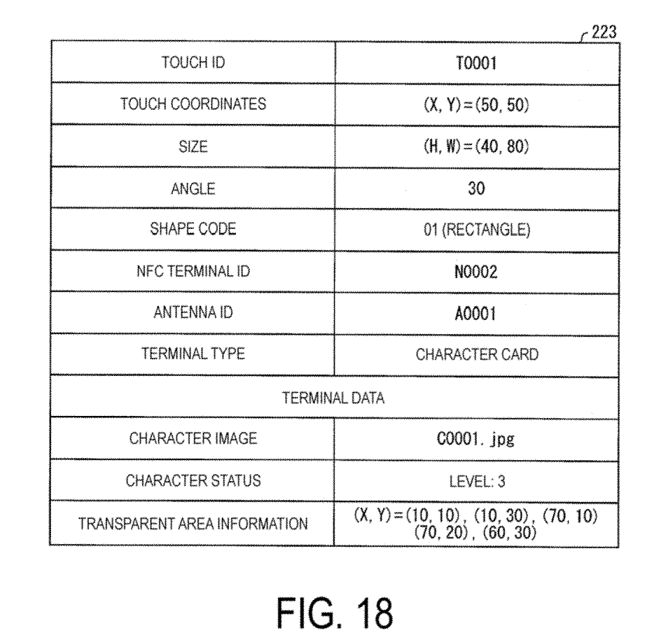

In contrast, in a case that the touch information indicates contact with an NFC terminal, that is, the association unit 213 determines that the above-described specific information is included, the association unit 213 checks whether the NFC information has been acquired from the NFC control unit 12. Here, in a case that the NFC information has been acquired, the association unit 213 associates the acquired touch information with the acquired NFC information to generate the association data 224, and stores the association data 224 in the storage unit 22b. Herein, the detailed description of the association data 224 will be given with reference to FIG. 18. FIG. 18 is a diagram illustrating a specific example of the association data 224. As illustrated in FIG. 18, the association data 224 includes a combination of the touch information described with reference to FIG. 16B, and the NFC information. Note that, in the present embodiment, a description will be given under the assumption that the NFC terminal serves as an NFC terminal 30 which is a character card used in an application of a character-raising game. The detailed descriptions of the application of the character-raising game and the character card will be given below. Also, as the various types of information included in the association data 224 have already been described, the description of the types of information will be omitted. The association unit 213 stores, in the storage unit 22b, the association data 224 including a combination of the touch information and the NFC information. In addition, the association unit 213 outputs the generated association data 224 to the application execution unit 211b.

In contrast, in a case that the NFC information has not been acquired, the association unit 213 checks the touch ID included in the acquired touch information, and checks whether association data 224 including the touch ID is present among the pieces of association data 224 stored in the storage unit 22b. In a case that such association data 224 is present, the touch information portion included in the association data 224 is updated to the contents of the acquired touch information. In this way, the NFC information generated by establishment NFC between the NFC terminal 30 and the information processing device 1b, as well as the touch information after movement of the NFC terminal 30, may be stored being associated with each other. This configuration enables the information processing device 1b to retain information indicating the most recent position of the NFC terminal 30 on the touch panel 114. Also, the association unit 213 outputs the updated association data 224 to the application execution unit 211b. Note that in a case that there is no association data 224 including the touch ID included in the acquired touch information, the association unit 223 deletes the acquired touch information.

In response to acquiring the touch information indicating contact of the pointer to launch the application, the application execution unit 211b according to the present embodiment executes an application 221 corresponding to the acquired touch information from among the applications 221 stored in the storage unit 22b. Next, the application execution unit 211b instructs the image generation unit 212 to generate an image.

Also, the application execution unit 211b according to the present embodiment references the association data 224 acquired from the association unit 213 to identify the area of the display unit 112 corresponding to the transparent area of the NFC terminal 30. Specifically, the application execution unit 211b references the touch coordinates, the size, and the transparent area information included in the association data 224 to identify the area of the display unit 112 corresponding to the proximity surface of the NFC terminal 30. Subsequently, the application execution unit 211b instructs the image generation unit 212 to generate an image matching the shape and size of the area indicated by the identified coordinates, and displays the image in the identified area.

### Processing Flow Executed by Information Processing Device 1b

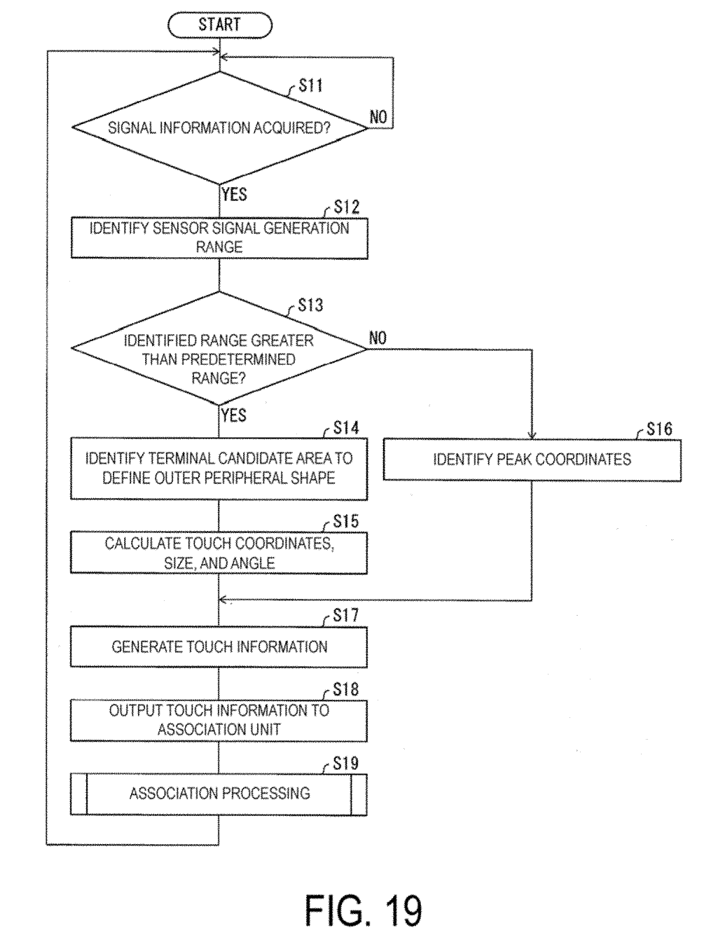

Next, a processing flow executed by the information processing device 1b will be described with reference to FIG. 19. FIG. 19 is a flowchart illustrating an example of a processing flow executed by the information processing device 1b.

First, the signal information processing unit 13 waits for signal information output from the touch panel 114 (S11). In a case that the signal information is acquired (YES in S11), the object determination unit 131 identifies the generation range of the sensor signal using the signal information (S12), and determines whether the range is wider than a predetermined range (S13). Next, the determination result is output to the touch information generation unit 132. In a case that the generation range of the sensor signal is less than or equal to the predetermined range (NO in S13), the touch information generation unit 132 identifies the peak coordinates in the sensor signal (S16).

In contrast, in a case that the generation range of the sensor signal is wider than the predetermined range (YES in S13), the touch information generation unit 132 identifies the terminal candidate area and defines the outer peripheral shape of this area (S14). Further, the touch information generation unit 132 calculates the touch coordinates, size, and angle of the rectangle (S15).

Next, the touch information generation unit 132 generates touch information (S17), and outputs the generated touch information to the association unit 213 (S18). Subsequently, the association unit 213 executes an association process (S19). The detailed description of the association process will be given below. Upon completion of the association process, the flow returns to step S11.

### Flow of Association Process

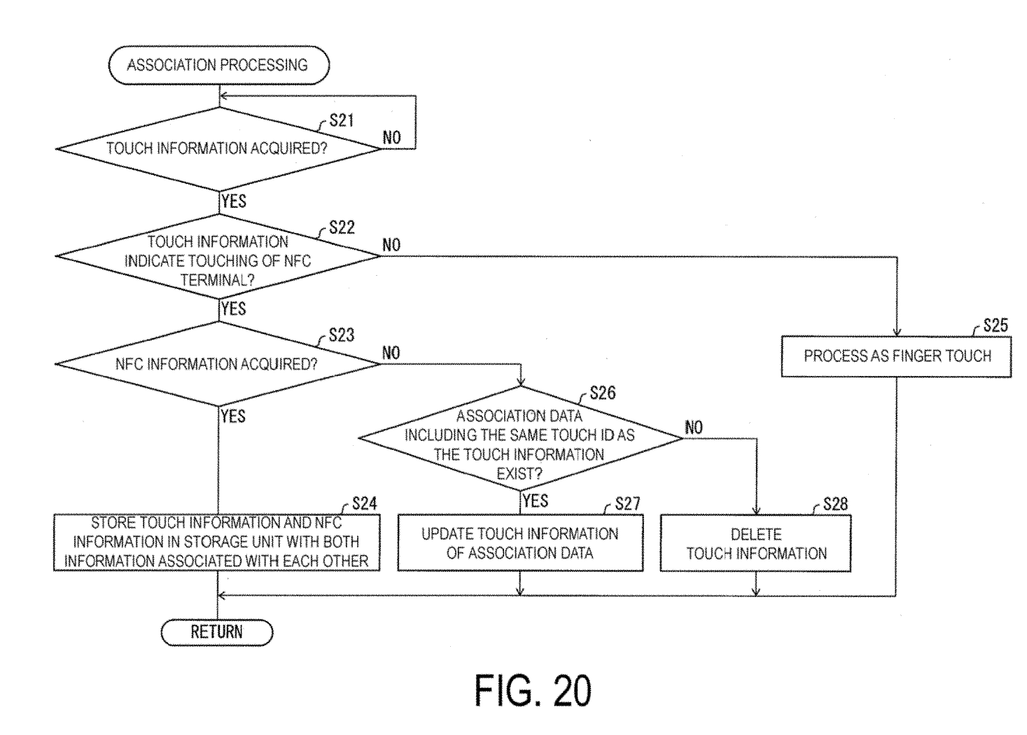

Next, a flow of the association process included in the flowchart of FIG. 19 will be described with reference to FIG. 20. FIG. 20 is a flowchart illustrating an example of a flow of the association process included in the flowchart of FIG. 19.

First, the association unit 213 is in a standby state to wait for the touch information (S21). In a case that touch information has been acquired (YES in S21), the association unit 213 determines whether the acquired touch information is touch information indicating contact of an NFC terminal (S22). Specifically, the association unit 213 determines whether the touch information is the touch information illustrated in FIG. 16B, that is, whether the touch information, indicating contact with the NFC terminal, includes specific information such as size, angle, and shape code. In a case that touch information indicating contact of the NFC terminal is not present (NO in S22), the association unit 213 process the touch indicated by the touch information as a finger touch (S25), and the association process is terminated.

In contrast, in a case that touch information indicating contact of an NFC terminal is present (YES in S22), the association unit 213 checks whether NFC information has been acquired (S23). In a case that NFC information has been acquired (YES in S23), the association unit 213 stores the touch information and the NFC information with both the pieces of information associated with each other in the storage unit 22b (S24), and the association process is terminated.

In contrast, in a case that NFC information has not been acquired (NO in S23), the association unit 213 checks whether association data 224 including the same touch ID as the acquired touch information is present (S26). In a case that the association data 224 is present (YES in S26), the association unit 223 updates the touch information portion of the association data 224 stored in the storage unit 22b (S27). Here, the association process is terminated.

In contrast, in a case that association data 224 is not present (NO in S26), the association unit 223 deletes the acquired touch information (S28). Here, the association process is terminated.

Note that, as a process flow for displaying the image in the image display area according to the present embodiment is substantially the same as that described in the first embodiment with reference to FIG. 9, the description of the process flow will be omitted. In the present embodiment, both transparent area information and touch information corresponding to the sensor signal are used together to calculate the image display area in step S4.

### Example of Application

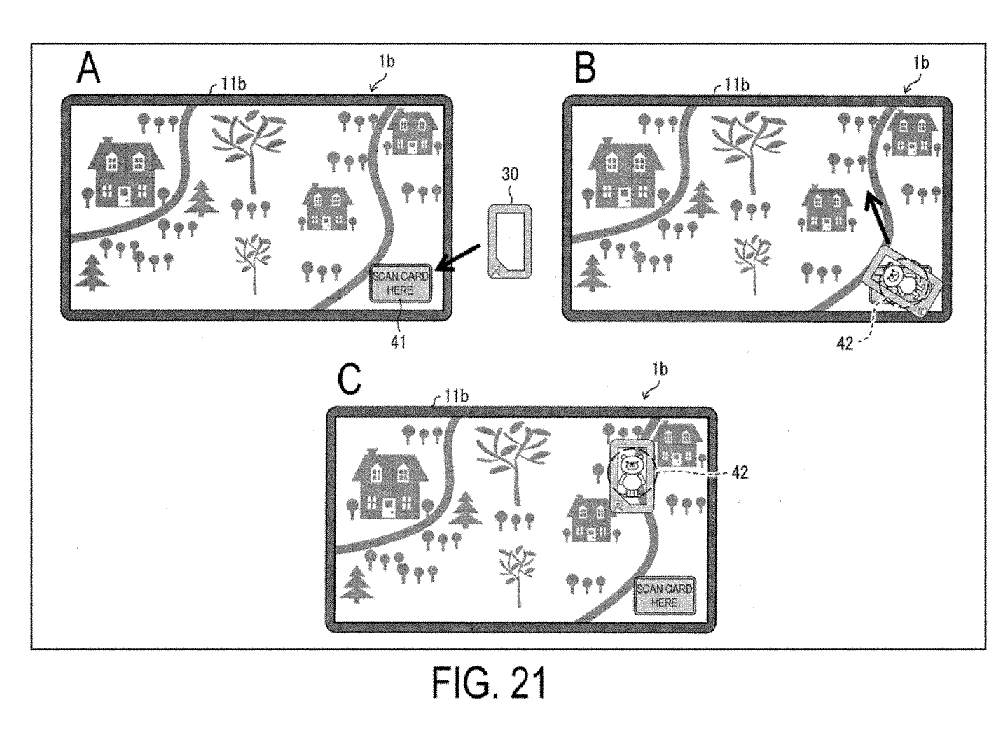

Next, an example of an application 221b executed by the information processing device 1b according to the present embodiment will be described with reference to FIG. 21. FIG. 21 is a transition diagram illustrating the information processing device 1b executing the application 221b.

The application 221b illustrated in FIG. 21 serves as an application for raising characters. Note that the application 221b is an example, and the applications executed by the information processing device 1b according to the present embodiment are not limited to this example.

As illustrated in A of FIG. 21, a user brings an NFC terminal (character card) 30 into contact with the NFC antenna 113. This causes the information retained by the NFC terminal 30, that is, the NFC terminal ID, the terminal type, and the terminal data (image data of the character, status of the character, as well as transparent area information) to be transmitted to the information processing device 1b.

Note that the display drive unit 23 displays a guide image 41 in the area of the display unit 112 corresponding to the position of the NFC antenna 113 to indicate, to the user, the position (the position of the NFC antenna 113) where the character card is to be brought into proximity to. This enables the user to easily recognize the position where the character card is to be brought into proximity to.

The association unit 213 associates the touch information on the character card at the position of the NFC antenna 113 with the NFC information including the information transmitted from the character card, stores this associated information in the storage unit 22 as association data 224, and outputs the association data 224 to the application execution unit 211b.

The application execution unit 211b references the association data 224 to identify the image display area. Next, information on the image display area and the image data of the character included in the NFC information are output to the image generation unit 212. This causes the image generation unit 212 to generate an image of the character indicated by the card. As illustrated in B of FIG. 21, this image is an image 42 having a size equal to or smaller than the size of the image display area, that is, a size equal to or smaller than the size of the transparent area 31 of the card. Note that the image generation unit 212 adjusts the size of the image of the character as necessary so that the image fits within the transparent area 31.

Subsequently, as illustrated in B of FIG. 21, the display drive unit 23 that has acquired the image generated by the image generation unit 212 displays the image.

Next, the user moves the character card while maintaining contact with the NFC display 11b. In response to this movement, the association unit 223 updates the touch information portion of the association data 224 for the character card stored in the storage unit 22b. Also, each time the association data 224 is updated, the association unit 213 outputs the updated association data 224 to the application execution unit 211b.

The application execution unit 211 references the association data 224 to identify the image display area. The image display area identified here corresponds to the position after the movement of the character card. Next, information on the image display area and the image data of the character included in the NFC information are output to the image generation unit 212. As illustrated in C of FIG. 21, this causes the display drive unit 23 to display the image 42 having a size equal to or smaller than the size of the transparent area 31 of the card at the position after the movement of the character card.

In a case that terminal data such as the status of the character changes in accordance with the progress of the raising game, the NFC control unit 12 may transmit the changed terminal data to the card using NFC. The information transmitted to the card is not limited to the status of the character, but may include, for example, information indicating the state of progress of the game or the like.

Also, although a configuration of the present embodiment has been described in which the character card retains information pertaining to a game, such as an image of a character and a status of a character, it is also possible for the character card to retain information for identifying the user in place of the game information. In such a configuration, in response to acquiring information for identifying the user, the application execution unit 211b accesses a server managing the raising game with the information, and acquires information on the game associated with the information for identifying the user.

As described above, the information processing device 1b according to the present embodiment associates NFC information including information received from the NFC terminal 30 with touch information. Next, an image that fits within the transparent area 31 of the NFC terminal 30 is displayed at the position indicated by the touch coordinates included in the touch information. This enables processing in which NFC information and touch information are linked. Also, as the size and angle of the NFC terminal 30 can be acquired from the touch information, the transparent area of the NFC terminal 30 can be accurately identified.

### Fourth Embodiment

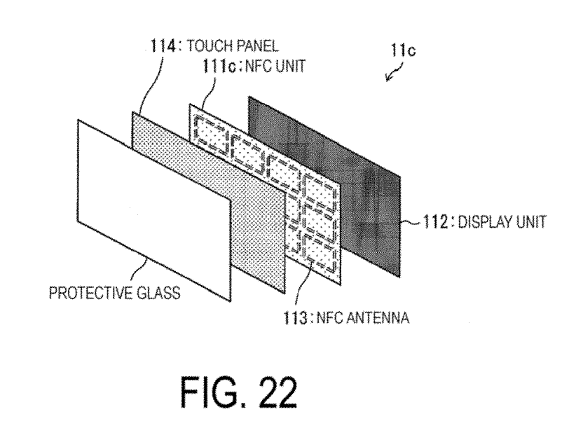

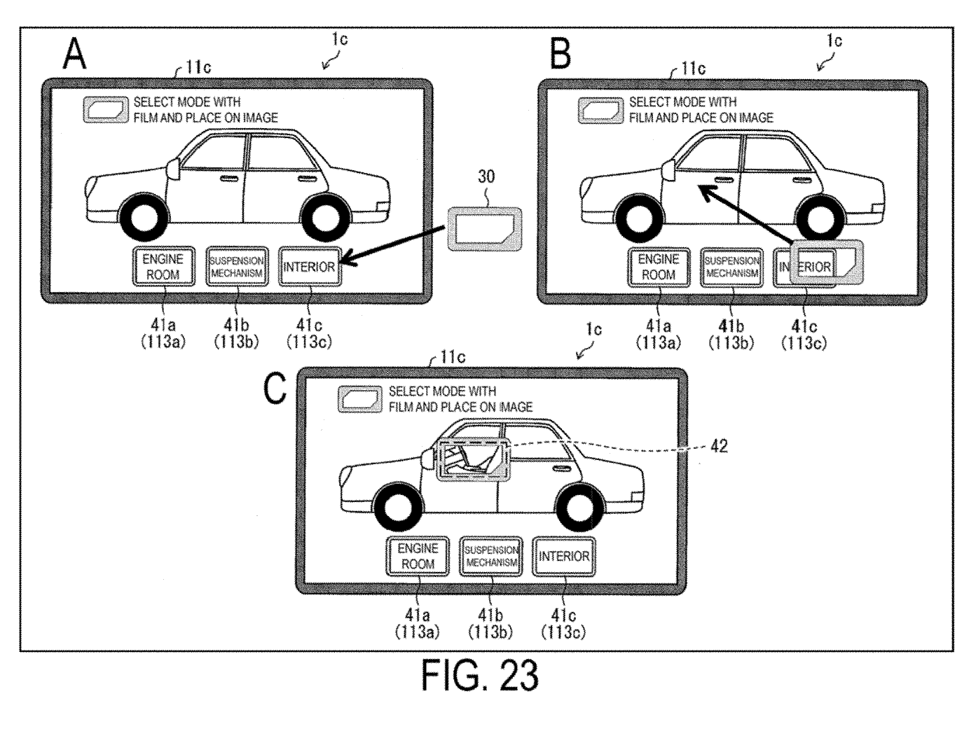

Still another embodiment of the invention will be described with reference to FIGS. 22 and 23. Note that, for convenience of explanation, components illustrated in respective embodiments are designated by the same reference numerals as those having the same function, and the descriptions of these components will be omitted.

FIG. 22 is a diagram illustrating a specific configuration of an NFC display 11c included in the information processing device 1c according to the present embodiment. In contrast to the NFC display 11b described in the third embodiment, the NFC display 11c includes an NFC unit 111c. In contrast to the NFC unit 111 described in the first embodiment, the NFC unit 111c includes a plurality of NFC antennas 113. Note that, although the plurality of NFC antennas 113 are arranged in a matrix in the NFC unit 111c illustrated in FIG. 22, the number and arrangement of the NFC antennas 113 are not limited to the example illustrated in FIG. 22. Note that different antenna IDs are set for each of the plurality of NFC antennas 113 according to the present embodiment.

Note that, as the information processing device 1c is substantially similar to the information processing device 1b described in the third embodiment with the exception that the NFC display 11c is provided in place of the NFC display 11b, a block diagram illustrating a primary configuration of the information processing device 1b and the description of each component will be omitted in the present embodiment.

### Example of Application

Next, an example of an application 221c executed by the information processing device 1c according to the present embodiment will be described with reference to FIG. 23. FIG. 23 is a transition diagram illustrating the information processing device 1c according to the present embodiment executing the application 221c.

The application 221c illustrated in FIG. 23 serves as an application for seeing the inside of a car, electronic device, or the like. Note that the application 221c is an example, and the application executed by the information processing device 1c according to the present embodiment is not limited to this example.

In response to receiving an instruction from the application execution unit 211b, the NFC control unit 12 activates an NFC antenna 113a, an NFC antenna 113b, and an NFC antenna 113c illustrated in A of FIG. 23 from among the plurality of NFC antennas 113. Next, as illustrated in A of FIG. 23, the display drive unit 23 displays a guide image 41a, a guide image 41b, and a guide image 41c generated by the image generation unit 212 in accordance with the instruction from the application execution unit 211b at the positions of the NFC antenna 113a, the NFC antenna 113b, and the NFC antenna 113c, respectively.

As illustrated in A and B of FIG. 23, a user brings the NFC terminal 30 (hereinafter, fluoroscopy card) into contact with any one of the NFC antenna 113a, the NFC antenna 113b, or the NFC antenna 113c on the NFC display 11c (in the example of FIG. 23, the user brings the NFC terminal 30 into contact with the NFC antenna 113c). This cause the information (e.g., NFC terminal ID, terminal type, transparent area information as terminal data) retained by the fluoroscopy card to be transmitted to the information processing device 1c.

Subsequently, the NFC control unit 12 associates the information received from the fluoroscopy card with the antenna ID indicating the NFC antenna 113c, and generates the NFC information. The NFC control unit 12 outputs the generated NFC information to the association unit 213.

Next, the association unit 213 associates the touch information on the fluoroscopy card at the position of the NFC antenna 113c with the acquired NFC information, and stores this associated information in the storage unit 22 as the association data 224. Further, the association unit 213 outputs the association data 224 to the application execution unit 211b.

Next, as illustrated in B of FIG. 23, with the fluoroscopy card in contact with the NFC display 11c, a user moves the fluoroscopy card to a position where the user desires to see the interior of the car. In response to this movement, the association unit 213 updates the touch information portion of the association data 224, and outputs the updated association data 224 to the application execution unit 211b.

Based on the antenna ID of the association data 224, the application execution unit 211b identifies an image to be displayed at the position of the fluoroscopy card (in the example of FIG. 23, an image of the interior of the car). Also, the application execution unit 211b references the touch coordinates and the transparent area information on the association data 224 to identify an area of the display unit 112 corresponding to the transparent area of the fluoroscopy card. Next, the application execution unit 211b identifies a portion corresponding to the identified area of the interior image of the car (not illustrated) stored in the storage unit 22, outputs information on the identified area to the image generation unit 212, and instructs the image generation unit 212 to generate an image of the identified portion.

The image generation unit 212 generates an image in accordance with the instruction from the application execution unit 211b, and outputs the generated image to the display drive unit 23 together with the acquired area information. As illustrated in C of 23, the display drive unit 23 displays the acquired image at the position of the display unit 112 indicated by the acquired area information.

As described above, in the information processing device 1c according to the present embodiment, the NFC control unit 12 identifies the NFC antenna 113 that has established the NFC. In a case that the NFC terminal 30 moves to a predetermined position (a position where the car is displayed), the image corresponding to the identified NFC antenna 113 is displayed in the area identified based on the position of the NFC terminal 30 and the transparent area of the NFC terminal 30. This configuration enables a user to view a different image corresponding to an NFC antenna 113 even in a case that the user changes the position of the NFC terminal 30 where the NFC terminal 30 is brought into contact with (i.e., the position of NFC antenna 113) and the resulting position of the NFC terminal 30 is the same. In other words, the user is able to cause the information processing device 1c to execute different processing by changing an NFC antenna 113 to which the NFC terminal 30 is brought into proximity.

### Fifth Embodiment

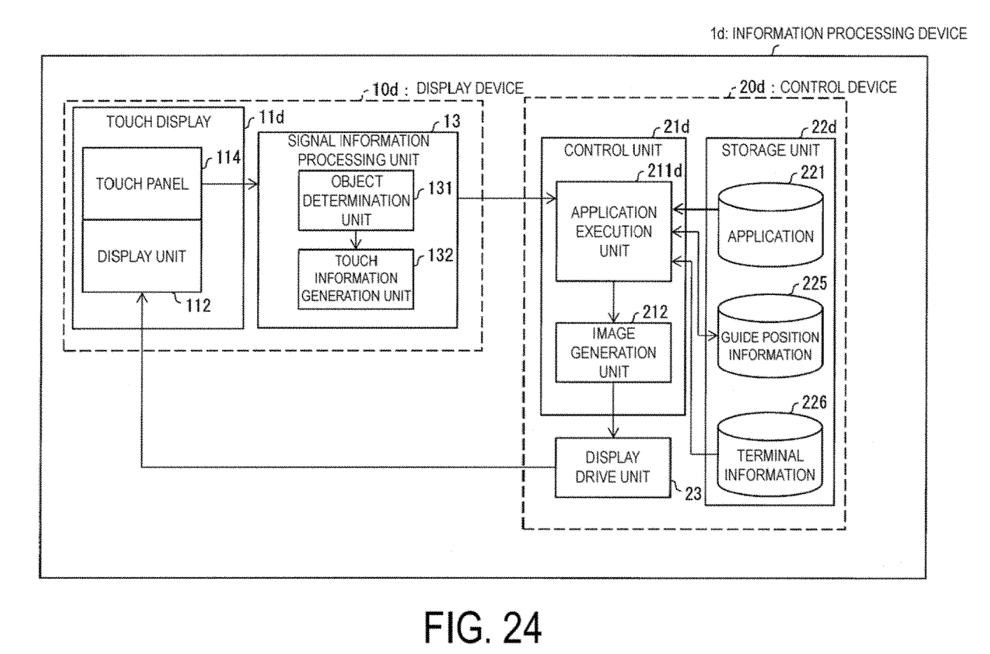

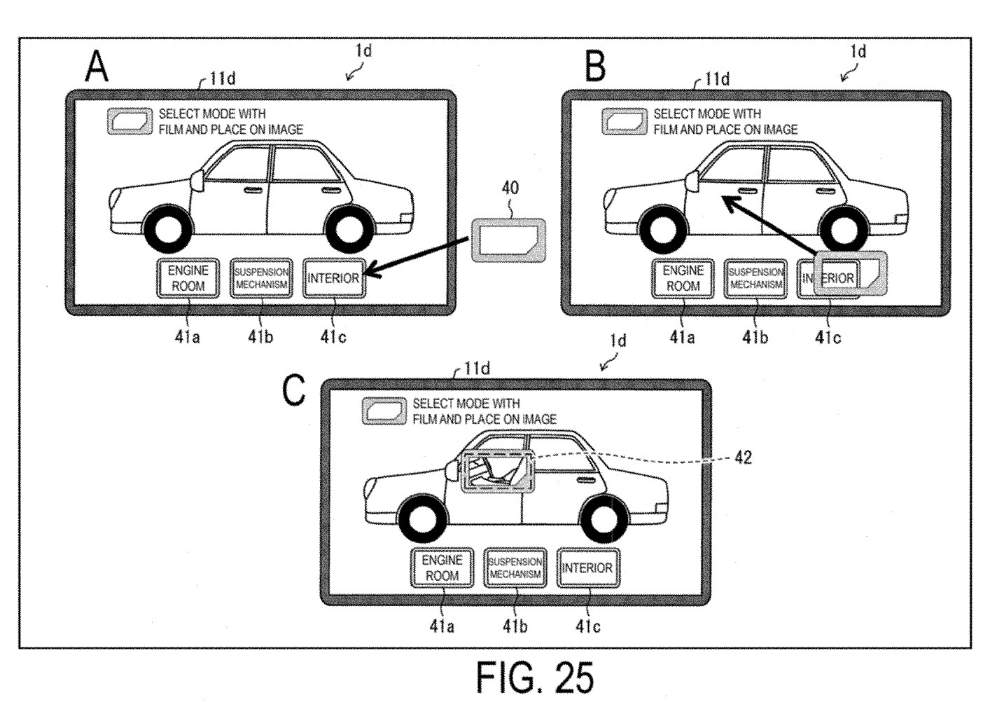

Still another embodiment of the invention will be described with reference to FIGS. 24 and 25. Note that, for convenience of explanation, components illustrated in respective embodiments are designated by the same reference numerals as those having the same function, and the descriptions of these components will be omitted.

FIG. 24 is a block diagram illustrating an example of a primary configuration of an information processing device 1d according to the present embodiment. In the information processing device 1d, a display device 10d for displaying images and a control device 20d for controlling the display device 10d are integrated as one unit. Note that, in the information processing device 1d, the display device 10d and the control device 20d may be separate units. In such a configuration, the display device 10d and the control device 20d transmits and receives information via a communication unit (not illustrated). Note that the transmission and reception of information may be performed in a wired or wireless fashion. Furthermore, the display device 10d and the control device 20d may transmit and receive information via another device such as a router.

In contrast to the information processing device 1 described in the first embodiment, the information processing device 1d need not include an NFC display 11 or an NFC control unit 12. Furthermore, the information processing device 1d additionally includes a touch display 11d. Furthermore, the information processing device 1d includes a signal information processing unit 13 as with the information processing device 1b described in the second embodiment. In addition, the information processing device Id includes a control unit 21d and a storage unit 22d in place of the control unit 21 and the control unit 22 described in the first embodiment.

The touch display 11d includes a display unit 112 and a touch panel 114. Note that, as the display unit 112 and the touch panel 114 have already been described in the first embodiment, the descriptions thereof will be omitted.

In contrast to the control unit 21 and the application execution unit 211 described in the first embodiment, the control unit 21d includes an application execution 211d.

In response to acquiring touch information indicating contact of a pointer to launch an application, the application execution unit 211d executes an application 221 corresponding to the acquired touch information from among the applications 221 stored in the storage unit 22d. Next, the application execution unit 211d instructs the image generation unit 212 to generate an image. At this time, the application execution unit 211d stores the position where the guide image is displayed as guide position information 225. In a case that, for example, the guide image is rectangular, the guide position information 225 includes the coordinates of each vertex of the guide image in an XY plane virtually formed on the display unit 112 (XY-plane coordinates based on the display resolution), but as long as the position and size of the guide image can be identified, the guide image information 225 is limited to this example. Note that, in the present embodiment, a description will be given under the assumption that a plurality of guide images are displayed, but the number of guide images to be displayed may be one.

Also, in response to acquiring the touch information from the signal information processing unit 13, the application execution unit 211d references the guide position information 225 to determine whether the touch coordinates indicated by the touch information are within the area indicated by the guide position information 225. Next, in a case that the application execution unit 211d determines that the guide image is within the range of the area, the application execution unit 211d identifies the guide image displayed in the area, and determines a process corresponding to the identified guide image. Next, the application execution unit 211d retains both the information indicating the identified guide image and the touch information with both the pieces of information associated with each other. Hereinafter, the associated information may be referred to as retained information. Note that the application execution unit 211d stores the information indicating the guide image and the touch information in the storage unit 22d with both the pieces of information associated with each other.

Next, the application execution unit 211d executes substantially the same process on subsequently acquired touch information. Here, in a case that the application execution unit 211d determines that the touch coordinates indicated by the acquired touch information are within the area of a guide image other than the previously identified guide image, the application execution unit 211 discards the retained information and associate the information indicating the other new guide image with the acquired touch information to form new retained information. Note that this process may be omitted in a case that there is only one guide image to be displayed.

In contrast, in a case that the application execution unit 211d determines that the touch coordinates indicated by the acquired touch information are not within the area of the other guide image (in a case where there is one displayed guide image or a case that new touch information is acquired), the application execution unit 211d updates the touch information included in the retained information.

In a case that the application execution unit 211d acquires touch coordinates indicating that the terminal device has moved to the predetermined position, the application execution unit 211 identifies the transparent area of the terminal device with the terminal information 226 stored in the storage unit 22d, and instructs the image generation unit 212 to generate an image corresponding to the guide image in the transparent area. The detailed description of this process will be described below.

Here, the terminal information 226 includes, for example, information for identifying the size of the transparent area of the terminal device and the position of the transparent area of the terminal device. For example, in a case that the shape of the terminal device is a rectangle, the terminal information 226 may include the transparent area shape code and the transparent area position information described in the first embodiment, but the terminal information 226 is not limited to this example. In addition, the terminal information 226 may include information indicating the shape and size of the proximity surface of the touch display 11d of the terminal device. In this case, the application execution unit 211d checks whether the difference between the shape code and the size included in the touch information and the shape and size of the proximity surface indicated by the terminal information 226 is within a predetermined range. In a case that the difference is not within the predetermined range, the application execution unit 211d may corrects the touch information using the touch information 226.

In contrast to the storage unit 22 described in the first embodiment, the storage unit 22d stores neither the NFC terminal information 222 nor the antenna position information 223. In addition, the storage unit 22d additionally stores guide position information 225 and terminal information 226. Note that, as the guide position information 225 and the terminal information 226 have already been described herein, the descriptions thereof will be omitted.

### Example of Application

Next, an example of the application 221d executed by the information processing device id according to the present embodiment will be described with reference to FIG. 25. FIG. 25 is a transition diagram illustrating the information processing device 1d according to the present embodiment executing the application 221d.

Similar to the application 221d described in the fourth embodiment, the application 221d illustrated in FIG. 25 serves as an application for seeing the inside of a car, electronic device, or the like. Note that the application 221d is an example, and the applications executed by the information processing device id according to the present embodiment are not limited to this example.

As illustrated in A of FIG. 25, the display drive unit 23 causes the display unit 112 of the touch display 11d to display the images generated by the image generation unit 212. The images include guide images 41a to 41c for displaying different fluoroscopic images.

As illustrated in A and B of FIG. 25, a user brings the terminal device 40 (hereinafter referred to as a fluoroscopy card) into contact with any one of the guide image 41a, the guide image 41b, or the guide image 41c (in the example of FIG. 25, the user brings the terminal device 40 into contact with the position of the guide image 41c). Note that, in contrast to the above-described NFC terminal 30, the terminal device 40 is a card-shaped terminal device incapable of Near field radio communication. Note that the terminal device 40 is not limited to the card-shaped terminal device illustrated in FIG. 25.

Bringing the terminal device 40 into contact with the position of the guide image 41c causes the application execution unit 211d to acquire the touch information generated by the signal information processing unit 13 in accordance with to the contact. The application execution unit 211d retains the acquired touch information and information indicating the guide image 41c with both pieces of information associated with each other.

Next, as illustrated in B of FIG. 25, the user moves the fluoroscopy card to a position where the user desires to see the interior of the car. In response to this movement, the application execution unit 211d updates the touch information included in the retained information. Next, from the information indicating the guide image, the application execution unit 211d identifies an image to be displayed at the position of the fluoroscopy card (in the case of FIG. 25, the image of the interior of the car). In addition, the application execution unit 211d references the touch coordinates and the terminal information 226 included in the touch information to identify the area of the display unit 112 corresponding to the transparent area of the fluoroscopy card. Next, the application execution unit 211b identities a portion corresponding to the identified area of the interior image of the car (not illustrated) stored in the storage unit 22, outputs information on the identified area to the image generation unit 212, and instructs the image generation unit 212 to generate an image of the identified portion.

The image generation unit 212 generates an image in accordance with the instruction from the application execution unit 211d and outputs the image to the display drive unit 23 together with the acquired area information. As illustrated in C of FIG. 25, the display drive unit 23 displays the acquired image at the position of the display unit 112 indicated by the acquired area information.

As described above, the information processing device 1d according to the present embodiment identifies the guide image displayed at the position where the terminal device 40 has been brought into contact with, and displays an image corresponding to the identified guide image in the transparent area of the terminal device 40 in a case that the terminal device 40 moves to a predetermined position (the position where the car is displayed). This configuration enables a user to view a different image corresponding to a guide image 41 even in a case that the user changes the position of the terminal device 40 where the terminal device 40 is brought into contact with (i.e., the position where the guide image 41 is displayed) and the resulting position of the terminal device 40 is the same. In other words, the user is able to cause the information processing device 1d to execute different processing by changing a guide image 41 with which the terminal device is brought into contact.

### Sixth Embodiment

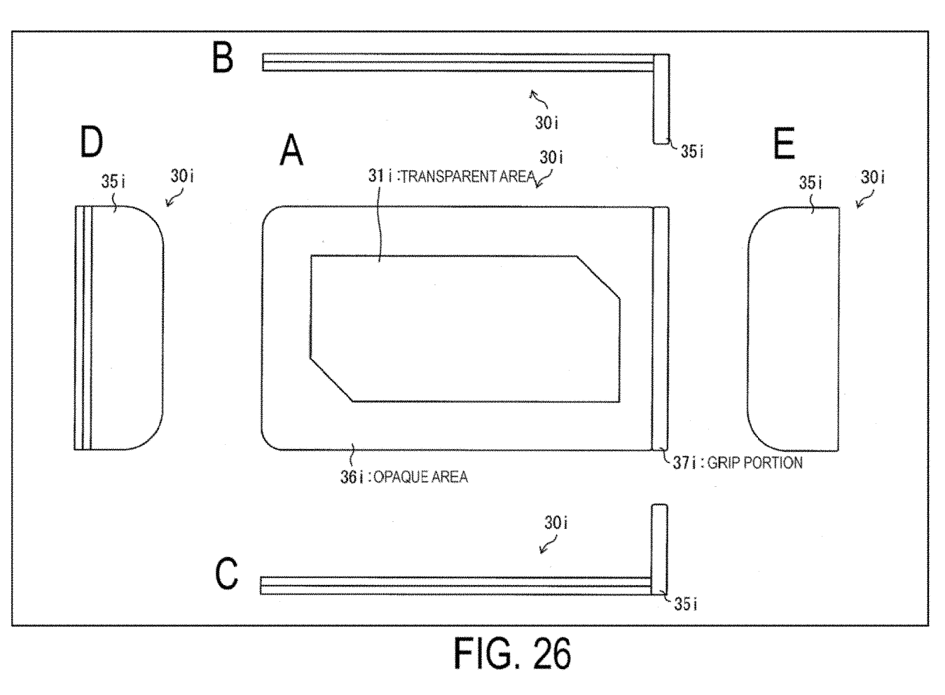

Still another embodiment of the invention will be described with reference to FIGS. 26 to 29. Note that, for convenience of explanation, components illustrated in respective embodiments are designated by the same reference numerals as those having the same function, and the descriptions of these components will be omitted.

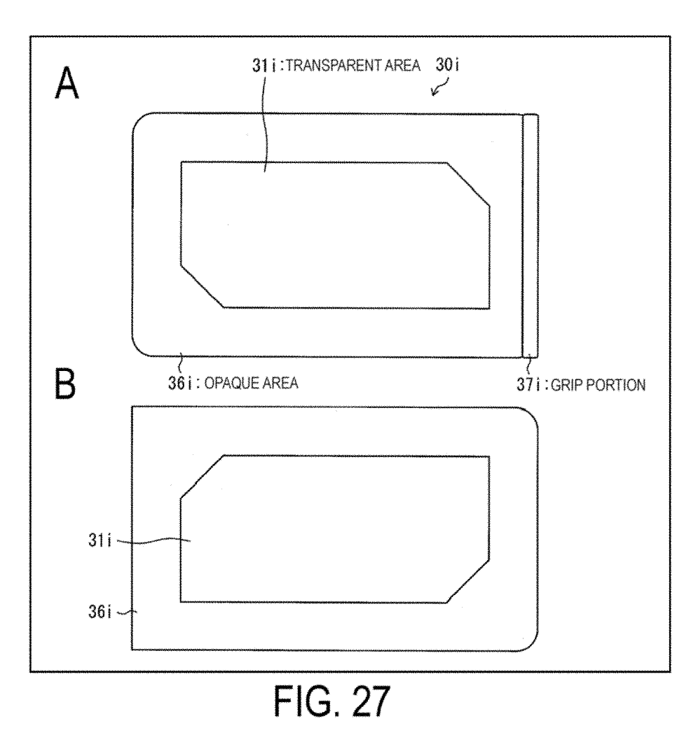

FIGS. 26 and 27 are diagrams illustrating each face of a card-shaped NFC terminal 30i according to the present embodiment as an orthographic drawing. A of FIG. 26 is a front view of the NFC terminal 30i, B of FIG. 26 is a plan view of the NFC terminal 30i, C of FIG. 26 is a bottom view of the NFC terminal 30i, D of FIG. 26 is a left side view of the NFC terminal 30i, and E of FIG. 26 is a right side view of the NFC terminal 30i. A of FIG. 27 is a front view of the NFC terminal 30i (the same as A of FIG. 26), and B of FIG. 27 is a rear view of the NFC terminal 30i.

As illustrated in FIG. 26, the NFC terminal 30i according to the present embodiment includes a transparent area 31i and an opaque area 36i, similar to the above-described NFC terminal 30. Furthermore, the NFC terminal 30i according to the present embodiment include a grip portion 37i at the right end portion in A of FIG. 26. The grip portion 37i is a plate-shaped member which a user can grip. Providing the NFC terminal 30i with the grip portion 37i enables a user to move the NFC terminal 30i using the grip portion 37i in a case that the user moves the NFC terminal 30i on the NFC display 11. This configuration enables the NFC terminal 30i to be easily moved on the NFC display 11.

Note that the NFC terminal 30i is not limited to a terminal including the grip portion 37i at the right end portion as illustrated in A of FIG. 26. For example, the NFC terminal 30i may include the grip portion 37i at the left end portion, the upper end portion, or the lower end portion in A of FIG. 26. Furthermore, the grip portion 37i may be provided extending from an end portion to the transparent area.

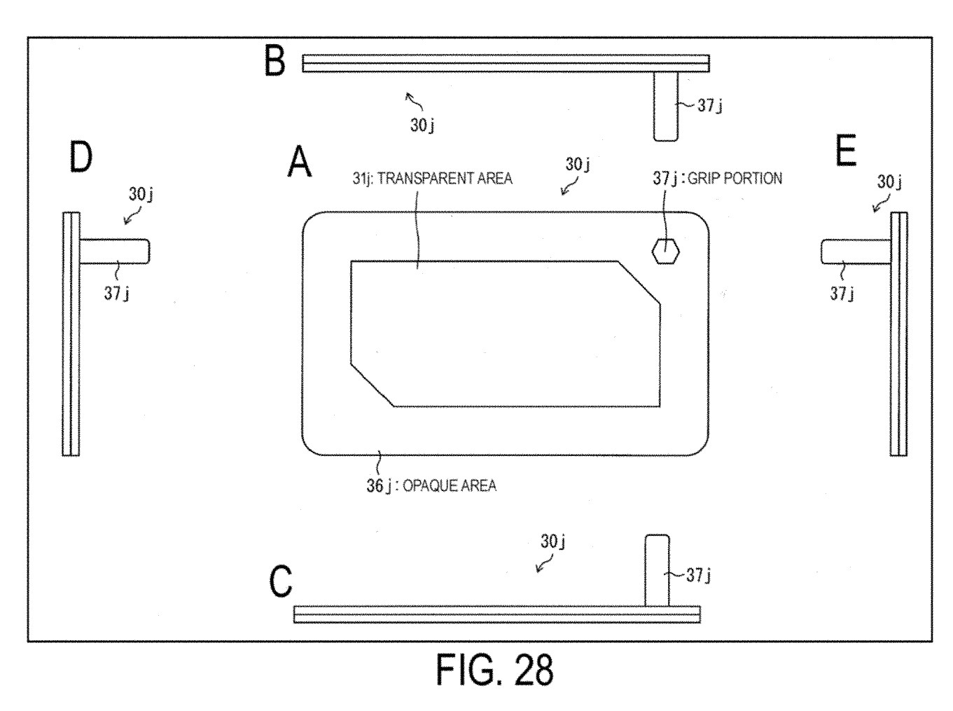

In addition, the grip portion is not limited to the plate-shaped grip portion 37i illustrated in FIG. 26. FIG. 28 is a diagram illustrating each face of an NFC terminal 30j as an orthographic drawing. A of FIG. 28 is a front view of the NFC terminal 30j, B of FIG. 28 is a plan view of the NFC terminal 30j, C of FIG. 28 is a bottom view of the NFC terminal 30j, D of FIG. 28 is a left side view of the NFC terminal 30j, and E of FIG. 28 is a right side view of the NFC terminal 30j. Note that, as the rear view of the NFC terminal 30j is the same as the rear view of the NFC terminal 30i illustrated in 13 of FIG. 27, the rear view of the NFC terminal 30j will be omitted.

As illustrated in FIG. 28, the NFC terminal may be an NFC terminal 30j including a rod-shaped grip portion 37j. That is, the grip portion provided on the NFC terminal 30 may be anything which the user can grip, and the structure of the grip portion is not particularly limited.

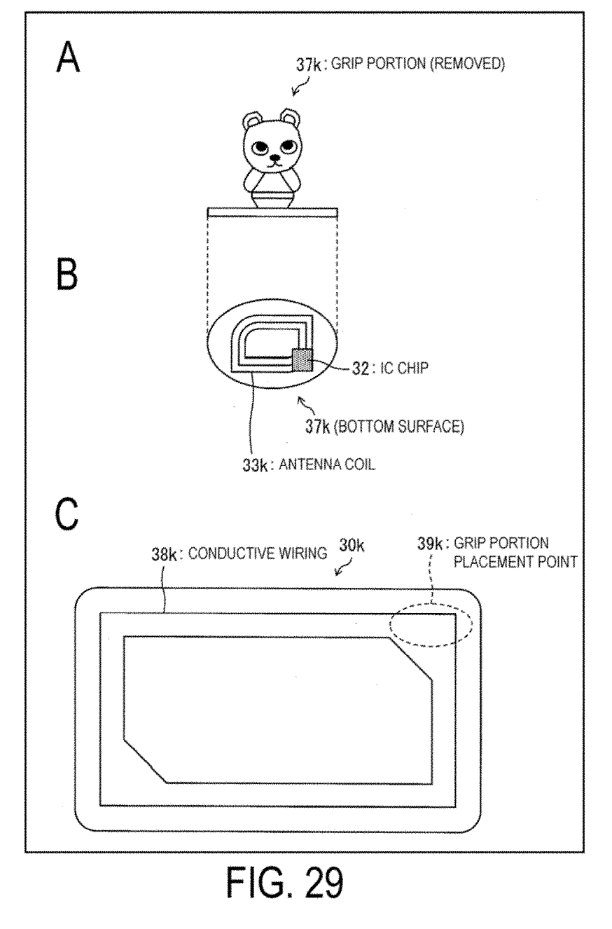

FIG. 29 is a diagram illustrating another example of the rod-shaped grip portion. For example, as illustrated in A of FIG. 29, the rod-shaped grip portion may be a grip portion 37k modeled after a character. In addition, as illustrated in FIG. 29, the grip portion 37k may be detachable from the NFC terminal 30.

In a case that the grip portion 37k is detachable, the components for Near field radio communication, such as the IC chip 32 and the antenna coil 33k, may be provided on the bottom surface of the grip portion 37k as illustrated in B of FIG. 29. This configuration enables the information processing device to display, for example, a different character, provided that the information on the character indicated by the grip portion 37k is stored in the IC chip 32 and the grip portion 37k attached to the NFC terminal 30k illustrated in C of FIG. 29 is replaced with a different grip portion indicating the different character. Accordingly, the NFC terminal 30k may be utilized as a shared terminal.

Note that, in a case that the touch panel 114 is configured to detect contact (or proximity) of the NFC terminal 30 as in the third embodiment, the NFC terminal 30 suitably includes conductive wiring 38k (see C of FIG. 29) matching the outer peripheral shape of the proximity surface, which enables the touch panel 114 to determine the shape of the proximity surface of the NFC terminal 30.

### Implementation Example by Software

The control blocks (in particular, the NFC control unit 12, the signal information processing unit 13, the control unit 21, the control unit 21b, the control unit 21d) of the information processing device 1 (as well as the information processing devices 1a to 1d) may be implemented by a logic circuit (hardware) formed on an integrated circuit (IC chip) or the like, or may be implemented by software using a Central Processing Unit (CPU).

In the latter configuration, the information processing device 1 includes a CPU for executing instructions of a program which is software for implementing each function, a Read Only Memory (ROM) or a storage device (each of these is referred to as a “recording medium”) in which the program and various types of data are recorded in a computer-readable (or CPU-readable) manner, a Random Access Memory (RAM) in which the program is loaded, and the like. Then, the computer (or CPU) reads the program from the recording medium and executes the program to achieve the object of the invention. As the recording medium, a “non-transitory tangible medium”, such as a tape, a disk, a card, a semiconductor memory, and a programmable logic circuit may be used. Further, the program may be supplied to the computer via any transmission medium (a communication network, a broadcast wave, or the like) able to transmit the program. Note that the invention may be implemented in a form of data signal embedded in a carrier wave, which is embodied by electronic transmission of the program.

### Summary

An information processing device 1 according to a first aspect of the invention includes: a display unit (NFC display 11) on which a terminal device (NFC terminal 30) including a light-transmitting (transparent area 31) portion is able to be placed, the display unit including a touch panel (touch panel 114); an area identification unit configured to identify, based on position information on the terminal device output from the touch panel in a case that the terminal device is placed on the display unit, an area of the display unit corresponding to the light-transmitting portion (application execution unit 211); and a display control unit (display drive unit 23) configured to display an image in the identified area.

According to the configuration described above, an area of the display unit corresponding to the light-transmitting portion of the terminal device may be identified based on the position information on the terminal device output from the touch panel, and an image may be displayed in the area. In other words, the touch panel is provided in order to identify the area of the display unit corresponding to the light-transmitting portion. This enables an image to be displayed overlapping with the light-transmitting portion, and allows the application of a smaller housing.

In an information processing device according to a second aspect of the invention, the area identification unit according to the first aspect may identify a position where the terminal device is in contact with or in proximity to the touch panel, and identify, at the position, an area of the display unit corresponding to the light-transmitting portion of the terminal device.

According to the above configuration, the position at which the terminal device is in contact with or in proximity to the touch panel may be identified, and the area of the display unit corresponding to the light-transmitting portion at the position may be identified. This allows the position of the terminal device to be accurately identified, which in turn makes it possible to accurately identify the position of the light-transmitting area of the terminal device as well as the area of the display unit corresponding to the light-transmitting area. This in turn enables an image to be displayed visible to a user.

In an information processing device according to a third aspect of the invention, the display unit according to the first aspect or the second aspect may further include a communication unit (NFC antenna 113) configured to establish Near field radio communication with the terminal device.

The above-described configuration enables Near field radio communication to be established with the terminal device, which allows information held by the terminal device to be acquired.

In an information processing device according to a fourth aspect of the invention, the area identification unit according to the third aspect may use information indicating the light-transmitting portion of the terminal device to identify an area of the display unit corresponding to the light-transmitting portion, the information being acquired by Near field radio communication with the terminal device.

According to the above-described configuration, information indicating the light-transmitting portion of the terminal device may be acquired by Near field radio communication, and an area of the display unit corresponding to the light-transmitting portion may be identified using the information. This enables the area of the display unit corresponding to the light-transmitting portion to he identified even in a case that the information processing device does not have information indicating the light-transmitting portion in advance. Also, as the terminal device has the information indicating the light-transmitting portion, even in a case that the size and shape of the light-transmitting portion are changed depending on the terminal device, the area of the display unit corresponding to the light-transmitting portion can be identified.

In an information processing device according to a fifth aspect of the invention, the display control unit according to the third aspect or the fourth aspect may display an image corresponding to information acquired by Near field radio communication with the terminal device.

According to the above-described configuration, as an image corresponding to the information acquired from the terminal device is displayed, cooperative image display using the terminal device and the information processing device may be possible. For example, it is possible to acquire information stored in the terminal device for identifying a user and display an image unique to the user.

In an information processing device according to a sixth aspect of the invention, the display unit according to any one of the third through fifth aspects may further include a plurality of the communication units and an identification unit (NFC control unit 12) configured to identify which communication unit of the plurality of communication units has established Near field radio communication with the terminal device.

According to the above-described configuration, as the communication unit which has established Near field radio communication may be identified from among the plurality of communication units, it is possible to identify the position where the terminal device has been brought into proximity to. This makes it possible to identify the position at which the image should be displayed.

In an information processing device according to a seventh aspect of the invention, the display control unit according to the sixth aspect may display an image corresponding to the communication unit identified by the identification unit.

According to the above-described configuration, an image corresponding to the communication unit identified by the identification unit may be displayed, That is, based on the position where the terminal device is brought into proximity to, a user can display different images on the display unit. Accordingly, it is possible to increase the width of the image to be displayed on the display unit. For example, even in a case that images are displayed at the same position, different images can be displayed in a case that a preceding communication unit brought into proximity is different.

In an information processing device according to an eighth aspect of the invention, the display control unit according to any one of the third to seventh aspects may display a guide image indicating the position of the communication unit within the area of the display unit corresponding to the position of the communication unit.

According to the above-described configuration, as the guide image is displayed in the area of the display unit corresponding to the position of the communication unit, a user may easily understand the position, to which the terminal device is brought into proximity, to establish Near field radio communication.

A method for controlling an information processing device according to a ninth aspect of the invention is a control method for an information processing device including a display unit on which a terminal device including a light-transmitting portion is able to be placed, the display unit including a touch panel. Such a method includes an area identification step (S4) for identifying, based on position information on the terminal device output from the touch panel in a case that the terminal device is placed on the display unit, an area of the display unit corresponding to the light-transmitting portion; and a display control step (S6) for displaying an image in the identified area.

The method for controlling the information processing device according to the ninth aspect may achieve the same effects as the information processing device according to the above-described first aspect.

An information processing device 1 according to a tenth aspect of the invention includes a display unit (NFC display 11) including a communication unit (NFC antenna 113) configured to establish Near field radio communication with a terminal device (NFC terminal 30) including a light-transmitting portion (transparent area 31), a storage unit (storage unit 22) configured to store communication position information (antenna position information 223) indicating a position of the communication unit in the display unit, a terminal position identification unit (application execution unit 211) configured to identify, in response to establishment of Near field radio communication, a position where the terminal device is in contact with or in proximity to the display unit using the communication position information, an area identification unit (application execution unit 211) configured to identify an area of the display unit corresponding to the light-transmitting portion of the identified terminal device, and a display control unit (display drive unit 23) configured to display an image in the identified area.

According to the above-described configuration, using the communication position information stored in the storage unit to identify the position of the display unit where the terminal device is in contact with or in proximity to causes an area of the display unit corresponding to the light-transmitting portion of the terminal device to be identified and causes an image to be displayed in the area. In other words, even without a configuration for identifying the position of the terminal device, the information processing device is able to identify the position of the terminal device. This enables an image to be displayed overlapping with the light-transmitting portion, and allows the application of a smaller housing.

A terminal device (NFC terminal 30) according to an eleventh aspect of the invention is configured to establish Near field radio communication with an external device by being placed on a display unit (NFC display 11) of the external device. Such a terminal device includes a light-transmitting portion (transparent area 31) through which at least a portion of an image displayed on the display unit is visible in a case that the terminal device is placed on the display unit.

According to the above-described configuration, with the light-transmitting portion through which at least a portion of an image displayed on the display unit is visible, a user is able to view at least a portion of the image displayed at the position overlapping with the terminal device. This can increase the degree of freedom for images displayed based on Near field radio communication with terminal devices.

In a terminal device according to a twelfth aspect of the invention, the light-transmitting portion according to the eleventh aspect may be formed by a cavity.

According to the above-described configuration, the light-transmitting portion may be formed by a cavity 313. Accordingly, in comparison with the configuration in which the light-transmitting portion is formed of a transparent material, the visibility of an image displayed at a position overlapping with the light-transmitting portion is not degraded due to dirt or scratches on the light-transmitting portion.

The information processing device according to each aspect of the invention may be implemented by a computer. In this case, a control program for the information processing device which causes the computer to function as each unit (software module) included in the information processing device and a computer-readable recording medium storing the control program fall within the scope of the invention.

The invention is not limited to each of the above-described embodiments. It is possible to make various modifications within the scope of the claims. An embodiment obtained by appropriately combining technical elements each disclosed in different embodiments falls also within the technical scope of the invention. Furthermore, technical elements disclosed in the respective embodiments may be combined to provide a new technical feature.

### INDUSTRIAL APPLICABILITY

The present invention can be used for information processing devices which process information acquired by Near field radio communication from display devices including communication units which establish Near field radio communication.

### REFERENCE SIGNS LIST

1 Information processing device
11 NFC display (Display unit)
12 NFC control unit (Identification unit)
23 Display drive unit (Display control unit)
30 NFC terminal (Terminal device)
31 Transparent area (Light-transmitting portion)
113 NFC antenna (Communication unit)
114 Touch panel
211 Application execution unit (Area identification unit, Terminal position identification unit)
313 Cavity
S4 Area identification step
S6 Display control step

1. An information processing device comprising:
a display unit on which a terminal device including a light-transmitting portion is able to be placed, the display unit including a touch panel;
an area identification unit configured to identify, based on position information on the terminal device output from the touch panel in a case that the terminal device is placed on the display unit, an area of the display unit corresponding to the light-transmitting portion; and
a display control unit configured to display an image in the identified area.

2. The information processing device according to claim 1,
wherein the area identification unit is configured to:
identify a position where the terminal device is in contact with or in proximity to touch panel; and
identify, at the position, an area of the display unit corresponding to the light-transmitting portion of the terminal device.

3. The information processing device according to claim 1,
wherein the display unit further includes a communication unit configured to establish Near field radio communication with the terminal device.

4. The information processing device according to claim 3,
wherein the area identification unit is configured to use information indicating the light-transmitting portion of the terminal device to identify an area of the display unit corresponding to the light-transmitting portion, the information being acquired by Near field radio communication with the terminal device.

5. The information processing device according to claim 3,
wherein the display control unit is configured to display an image based on the information acquired by Near field radio communication with the terminal device.

6. The information processing device according to claim 3,
wherein the display unit further comprises:
a plurality of the communication units; and
identification unit configured to identify which communication unit of the plurality of communications units has established Near field radio communication with the terminal device.

7. The information processing device according to claim 6,
wherein the display control unit is configured to display an image corresponding to the communication unit identified by the identification unit.

8. The information processing device according to claim 3,
wherein the display control unit is configured to display, within an area of the display unit corresponding to a position of the communication unit, a guide image indicating the position of the communication unit.

9. (canceled)

10. An information processing device comprising:
a display unit including a communication unit configured to establish Near field radio communication with a terminal device including a light-transmitting portion;
a storage unit configured to store communication position information indicating a position of the communication unit in the display unit;
a terminal position identification unit configured to identify, in response to establishment of Near field radio communication, a position where the terminal device is in contact with or in proximity to in the display unit using the communication position information;
an area identification unit configured to identify an area of the display unit corresponding to the light-transmitting portion of the identified terminal device; and
a display control unit configured to display an image in the identified area.

11. A terminal device configured to establish Near field radio communication with an external device by being placed on a display unit of the external device, the terminal device comprising:
a light-transmitting portion through which at least a portion of an image displayed on the display unit is visible in a case that the terminal device is placed on the display unit.

12. The terminal device according to claim 11,
wherein the light-transmitting portion is formed by a cavity.

13. A non-transitory computer-readable recording medium configured to store a control program causing a computer to function as the information processing device according to claim 1, the control program configured to:
cause a computer to function as the area identification unit and the display control unit.

14. (canceled)
